(19) United States
(12) Patent Application Publication
(10) Pub. No.: US 2024/0316458 A1
(43) Pub. Date: Sep. 26, 2024

(54) INFORMATION DISPLAY

(71) Applicant: Tencent Technology (Shenzhen) Company Limited, Shenzhen (CN)

(72) Inventors: Xiaofeng CHEN, Shenzhen (CN); Yuanyuan PEI, Shenzhen (CN); Yun AI, Shenzhen (CN); Xingqi ZHOU, Shenzhen (CN)

(73) Assignee: Tencent Technology (Shenzhen) Company Limited, Shenzhen (CN)

(21) Appl. No.: 18/737,751

(22) Filed: Jun. 7, 2024

Related U.S. Application Data
(63) Continuation of application No. PCT/CN2023/108910, filed on Jul. 24, 2023.

(30) Foreign Application Priority Data
Sep. 9, 2022 (CN) 202211105826.5

(51) Int. Cl. A63F 13/53

(52) U.S. Cl. CPC A63F 13/53

(57) ABSTRACT

A method for information display includes displaying, during a process of a current game task that includes a first virtual character, the first virtual character and a virtual interactive prop in the current game task. The method also includes, when a projection display operation is performed on the virtual interactive prop, displaying a virtual projection associated with a second virtual character that is included in the current game task and satisfies a projection condition. The virtual projection includes at least one of a character model projection of the second virtual character and a game data projection of the second virtual character. Apparatus and non-transitory computer-readable storage medium counterpart embodiments are also contemplated.

### RELATED APPLICATIONS

The present application is a continuation of International Application No. PCT/CN2023/108910, entitled “INFORMATION DISPLAY METHOD AND APPARATUS, STORAGE MEDIUM AND ELECTRONIC DEVICE” and filed on Jul. 24, 2023, which claims priority to Chinese Patent Application No. 202211105826.5, entitled “INFORMATION DISPLAY METHOD AND APPARATUS, STORAGE MEDIUM, AND ELECTRONIC DEVICE” and filed on Sep. 9, 2022. The entire disclosures of the prior applications are hereby incorporated by reference.

### FIELD OF THE TECHNOLOGY

Embodiments of this disclosure relate to the field of computers, including techniques for information display.

### BACKGROUND OF THE DISCLOSURE

In a virtual game scene, information may be displayed in various manners. For example, information about a virtual character may be displayed in a fixed location. However, this manner is excessively rigid and inflexible, and has the problem of low information display efficiency.

For the foregoing problem, no effective solution has been provided at present.

### SUMMARY

Embodiments of this disclosure provide an information display method and apparatus, a storage medium, and an electronic device, to resolve at least a technical problem of low information display efficiency.

According to an aspect of an embodiment of this disclosure, a method for information display includes displaying, during a process of a current game task that includes a first virtual character, the first virtual character and a virtual interactive prop in the current game task. The method also includes, when a projection display operation is performed on the virtual interactive prop, displaying a virtual projection associated with a second virtual character that is included in the current game task and satisfies a projection condition. The virtual projection includes at least one of a character model projection of the second virtual character and a game data projection of the second virtual character.

According to another aspect of an embodiment of this disclosure, an information display apparatus includes processing circuitry configured to display a first virtual character and a virtual interactive prop in a current game task that includes the first virtual character during a process of the current game task. The processing circuitry is further configured to, when a projection display operation is performed on the virtual interactive prop, display a virtual projection associated with a second virtual character that is included in the current game task and satisfies a projection condition. The virtual projection includes at least one of a character model projection of the second virtual character and a game data projection of the second virtual character.

According to still another aspect of an embodiment of this disclosure, a computer program product or a computer program is provided, including computer instructions stored in a computer-readable storage medium. A processor of a computer device reads the computer instructions from the computer-readable storage medium, and the processor executes the computer instructions, so that the computer device performs the above information display method.

According to still another aspect of an embodiment of this disclosure, an electronic device is further provided, including a memory, a processor, and a computer program stored on the memory and executable on the processor, the processor performing the above information display method by using the computer program.

In the embodiments of the present disclosure, in the running process of the first virtual character participating in the current game task, the first virtual character and the virtual interactive prop are displayed. In response to the projection display operation performed on the virtual interactive prop, the virtual projection corresponding to the second virtual character is displayed, the second virtual character being a virtual character that satisfies a projection condition and that are of virtual characters participating in the current game task, and the virtual projection including at least one of a character model projection of the second virtual character and a game data projection of the second virtual character. On a client in which the first virtual character is located, the first virtual character and the virtual interactive prop are displayed. After the projection display operation performed on the virtual interactive prop is detected, the virtual projection corresponding to the second virtual character is displayed on the client. By associating the virtual interactive prop with the virtual projection, autonomous display of the virtual projection is achieved through an interactive behavior performed on the virtual interactive prop.

Besides, since the autonomous display does not constrain the location of the virtual projection, a player no longer needs to move to a fixed and designated location to view the displayed virtual projection, and instead the player autonomously determines when and where to view the displayed virtual projection, thereby providing the player with an efficient information (virtual projection) display manner and improving information display efficiency, to solve the technical problem of low information display efficiency.

### BRIEF DESCRIPTION OF THE DRAWINGS

The accompanying drawings described herein are used to provide a further understanding of this disclosure, and form part of this disclosure. Exemplary embodiments of this disclosure and descriptions thereof are used to explain this disclosure, and do not constitute any inappropriate limitation to this disclosure. In the accompanying drawings:

FIG. 1 is a schematic diagram of an application environment of an information display method according to an embodiment of this disclosure;

FIG. 2 is a schematic flowchart of an information display method according to an embodiment of the present disclosure;

FIG. 3 is a schematic diagram of an information display method according to an embodiment of this disclosure;

FIG. 4 is a schematic diagram of another information display method according to an embodiment of this disclosure;

FIG. 5 is a schematic diagram of another information display method according to an embodiment of this disclosure;

FIG. 6 is a schematic diagram of another information display method according to an embodiment of this disclosure;

FIG. 7 is a schematic diagram of another information display method according to an embodiment of this disclosure;

FIG. 8 is a schematic diagram of another information display method according to an embodiment of this disclosure;

FIG. 9 is a schematic diagram of another information display method according to an embodiment of this disclosure;

FIG. 10 is a schematic diagram of another information display method according to an embodiment of this disclosure;

FIG. 11 is a schematic diagram of another information display method according to an embodiment of this disclosure;

FIG. 12 is a schematic diagram of another information display method according to an embodiment of this disclosure;

FIG. 13 is a schematic diagram of another information display method according to an embodiment of this disclosure;

FIG. 14 is a schematic diagram of another information display method according to an embodiment of this disclosure;

FIG. 15 is a schematic diagram of an information display apparatus according to an embodiment of this disclosure; and

FIG. 16 is a schematic structural diagram of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

In the specification, claims, and the foregoing accompanying drawings of the present disclosure, the terms “first”, “second”, and so on are intended to distinguish between similar objects rather than indicating a specific order. Such used data is interchangeable where appropriate so that the embodiments of this disclosure described here may be implemented in an order other than those illustrated or described here. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, product, or device.

According to an aspect of an embodiment of this disclosure, an information display method is provided. In some examples, as an implementation, the information display method may be applied to, but is not limited to, an environment shown in FIG. 1. The environment may include, but is not limited to, a user device 102 and a server 112. The user device 102 may include, but is not limited to, a display 104, a processor 106, and a memory 108. The server 112 includes a database 114 and a processing engine 116.

A specific process may include the following operations:
Operation S102: The user device 102 obtains a projection display operation performed on a virtual interactive prop, where the virtual interactive prop and a first virtual character are displayed in a running process of the first virtual character participating in a current game task.
Operations S104 to S106: Send the projection display operation to the server 112 through a network 110.
Operation S108: The server 112 determines, through a processing engine and in response to the projection display operation, a virtual projection corresponding to a second virtual character, where the second virtual character is a virtual character that satisfies a projection condition and that are of virtual characters participating in the current game task, and the virtual projection includes at least one of a character model projection of the second virtual character and a game data projection of the second virtual character.
Operations S110 to S112: Send the virtual projection corresponding to the second virtual character to the user device 102 through the network 110, and the user device 102 displays the virtual projection corresponding to the second virtual character on the display 104 through the processor 106, and stores the virtual projection corresponding to the second virtual character in the memory 108.

In addition to the example shown in FIG. 1, the operations may be completed independently by the client or the server, or jointly completed by the client and the server. For example, the user device 102 performs the operation such as determining, in response to the projection display operation, the virtual projection corresponding to the second virtual character, thereby reducing the processing pressure on the server 112. The user device 102 includes but is not limited to a handheld device (for example, a mobile phone), a laptop computer, a desktop computer, a vehicle-mounted device, or the like. This disclosure does not limit the specific implementation of the user device 102.

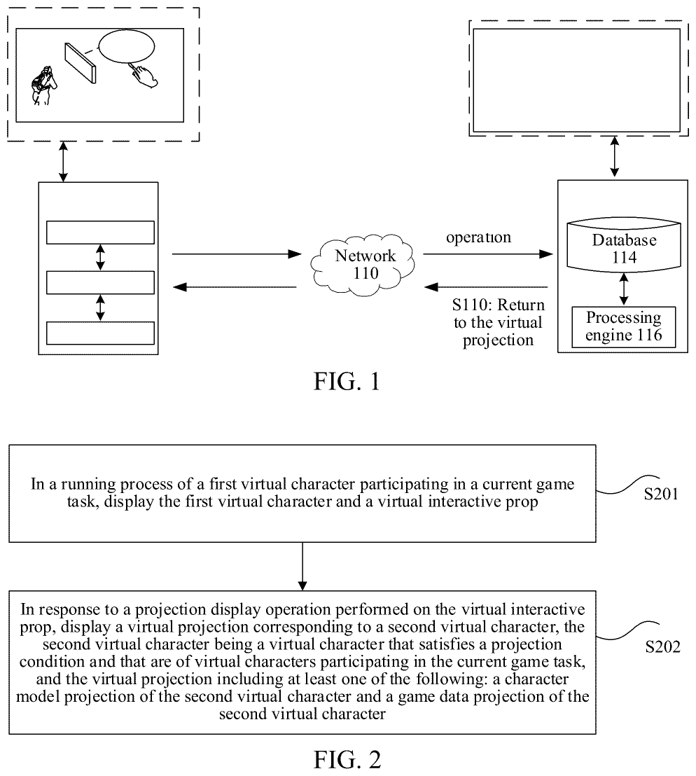

In some examples, as an implementation, as shown in FIG. 2, the information display method includes:
Operation S202: In a running process of a first virtual character participating in a current game task, display the first virtual character and a virtual interactive prop.
Operation S204: In response to a projection display operation performed on the virtual interactive prop, display a virtual projection corresponding to a second virtual character, the second virtual character being a virtual character that satisfies a projection condition and that are of virtual characters participating in the current game task, and the virtual projection including at least one of a character model projection of the second virtual character and a game data projection of the second virtual character.

In some examples, in this embodiment, the information display method may be applied to, but is not limited to, display scenarios of virtual character information in shooting games. For example, when a player performs a game task by controlling a virtual character in the game, there is fierce competition between players, but the players cannot accurately obtain information of each other. In some related technology, to observe equipment information of another player, the another player needs to be approached to visually inspect equipment of the another player to estimate combat power of the player. This has a huge risk.

In the information display method, by performing a projection display operation on a virtual interactive prop, a player may obtain virtual projection information corresponding to another player. The virtual projection information may include, but is not limited to, name information, equipment information, blood volume information, that is, combat power information, or the like of the player. For example, the player obtains virtual projection information of a master player through a virtual interactive prop. Based on name information and equipment displayed in the virtual projection information, the player may make corresponding decisions for the master player during subsequent task execution. Therefore, a player may obtain, in a game in real time based on a virtual interactive prop and a behavior of interacting with the player, information of another player who meets a condition in the current game.

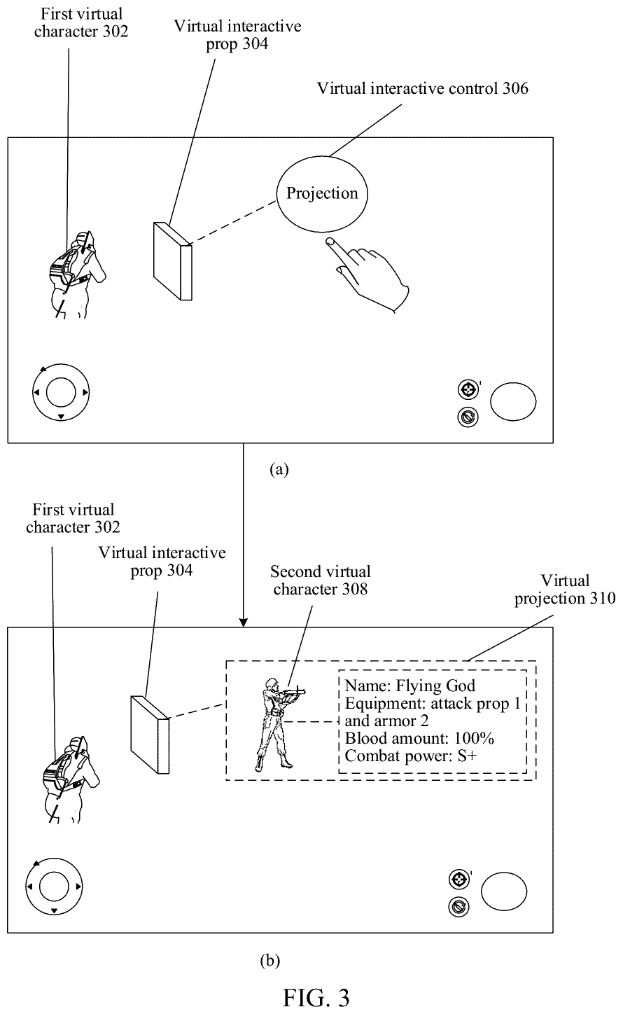

For another example, as shown in (a) of FIG. 3, a first virtual character 302 approaches a virtual interactive prop 304 and performs a projection display operation by clicking on a virtual interactive control 306 with the word “projection” displayed on the virtual interactive prop 304. In this way, as shown in (b) of FIG. 3, in response to the projection display operation performed on the virtual interactive control 306, a virtual projection 310 corresponding to a second virtual character 308 is displayed on a client in which the first virtual character 302 is located. The virtual projection 310 includes a 3D model and real-time game data “name: Flying God, equipment: attack prop 1, armor 2, and blood volume 100%, and combat power: S+” of the second virtual character 308. Based on this, the first virtual character 302 obtains information that the second virtual character 308 named Flying God is a master player who is in good condition and has strong combat power.

In some examples, in this embodiment, the information display method may be applied to, but is not limited to, display scenarios of equipment information in shooting games. For example, when a player controls a virtual character in a game to perform a game task, to improve the real-time combat power of the virtual character in the game, the player may constantly update more powerful virtual attack prop and equipment for the virtual character. In addition, the virtual attack prop and equipment are not entirely evaluated based on combat power. For example, a sniper rifle with a wider range is better than a rifle in a desert game environment, but a rifle with a faster assault capability is better than a sniper rifle in a plain game environment. Therefore, an attack prop needs to be evaluated for the player in the shooting game based on the actual game condition.

The virtual attack prop and equipment may include, but are not limited to, offensive attack props and equipment, such as sniper rifles, rifles, and shotguns, may further include, but are not limited to, defensive attack props and equipment, such as defensive armors and life armors, and may further include, but are not limited to, functional attack props and equipment, such as vehicles and magnifying glasses.

In the information display method, the player may control the virtual character, perform a projection display operation on the discovered virtual attack prop and equipment during game task execution, and display the equipment information corresponding to the virtual attack prop and equipment. The equipment information may include, but is not limited to, ranges, lethality, rates of fire, and other attribute information of offensive virtual attack props and equipment, and may further include, but is not limited to, life attributes, defense attributes, and other equipment information of defensive virtual attack props and equipment. Therefore, a player can accurately find and select virtual attack props and equipment that are most suitable for a virtual character based on the actual game condition, which improves the user experience of the game.

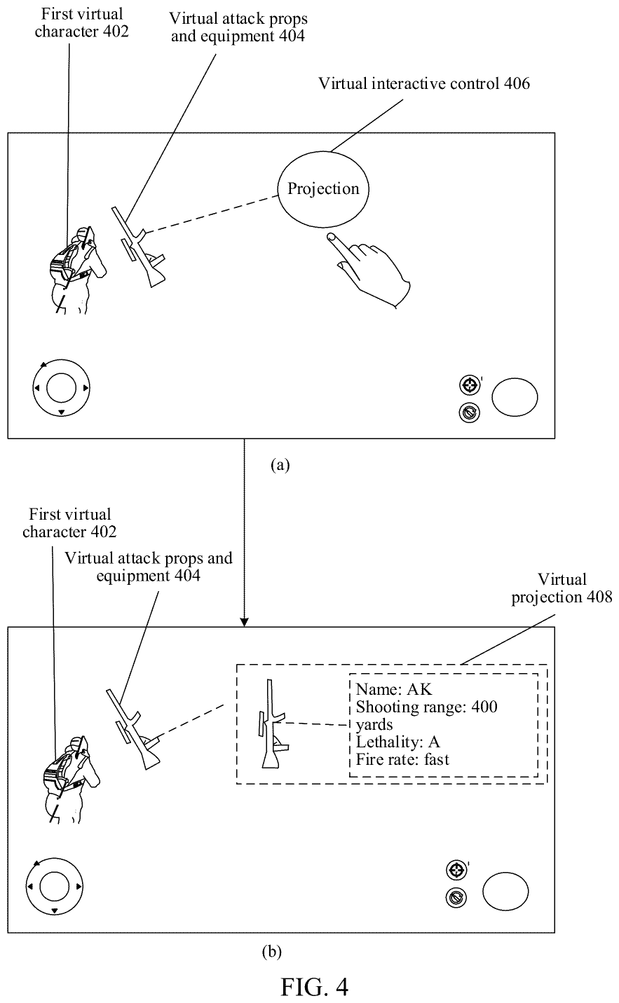

For another example, as shown in (a) of FIG. 4, a first virtual character 402 approaches virtual offensive prop equipment 404 and performs a projection display operation by clicking on a virtual interactive control 406 with the word “projection” displayed on the virtual offensive prop equipment 404. In this way, as shown in (b) of FIG. 4, in response to the projection display operation performed on the virtual interactive control 406, a virtual projection 408 corresponding to the virtual offensive prop equipment 404 is displayed on a client in which the first virtual character 402 is located. The virtual projection 408 includes a 3D model and real -time game data “name: AK, range: 400 yards, lethality: A, and rate of fire: fast” of the virtual offensive prop equipment 404. Based on this, the first virtual character 402 obtains specific information of the newly discovered virtual offensive prop equipment 404, and then determines, based on virtual attack prop and equipment information equipped on the first virtual character and current game live information, whether to execute an operation of picking up or storing or using the virtual offensive prop equipment 404.

In some examples, in this embodiment, the first virtual character may be, but is not limited to, a virtual character controlled by the player in the game. The virtual character may have, but is not limited to, corresponding attribute information based on the actual game condition. The attribute information may include, but is not limited to, a damage amount, a number of kills, a healing amount, a value of skin, or the like of the virtual character. The virtual interactive prop may be, but is not limited to, game props that provide interactive behavior to the first virtual character controlled by the player in the game, and may also be, but is not limited to, game props preset for the game preparation stage, or game props generated in real time based on the actual game condition, and may also be, but is not limited to, game props exchanged by players based on an exchange condition, so that players can customize the usage location of the virtual interactive prop and the display location of the virtual projection.

In some examples, in this embodiment, the projection triggering operation may be, but is not limited to, an interactive behavior performed by the first virtual character when a preset condition is met between the first virtual character and the virtual interactive prop. The displaying, in response to a projection display operation performed on the virtual interactive prop, a virtual projection corresponding to the second virtual character may be, but is not limited to, displaying the virtual projection corresponding to the second virtual character to the first virtual character, where the second virtual character may be, but is not limited to, a virtual character that satisfies the projection condition and that is of virtual characters of the player participating in the current game task in the game. For example, when the first virtual character meets the projection condition, the first virtual character may also be the second virtual character. In addition, the projection condition may be, but is not limited to, that one piece of attribute information of the virtual character meets a preset condition of a corresponding attribute, and may also be, but is not limited to, that a plurality of pieces of attribute information of the virtual character all meet preset conditions of corresponding attributes.

In some examples, in this embodiment, the projection triggering operation may also be, but is not limited to, a projection triggering operation performed when an area within a range in which the virtual interactive prop is located is set as a collision area and the virtual character controlled by the player enters the collision area.

In some examples, in this embodiment, in a game, there may be a plurality of virtual interactive props, but this constitutes no limitation, and the number of props in the game may be updated in real time based on the actual game condition, but this constitutes no limitation. Virtual interactive props may be, but are not limited to, game props of one or more different attribute types. In some examples, virtual interactive props of different attribute types correspond to different projection conditions. For example, the virtual interactive prop may be used to indicate a virtual character (“killing king”) with the largest number of kills in the current game, but this constitutes no limitation. The corresponding projection condition is the largest number of kills in the current game. The corresponding second virtual character is a virtual character with the largest number of kills in the current game. The virtual interactive prop may be used to indicate a virtual character (“killing king”) whose number of kills exceeds a preset number condition in the current game, but this constitutes no limitation. The corresponding projection condition is that the number of kills is greater than a preset number condition in the current game. The corresponding second virtual character is one or more of a plurality of virtual characters whose number of kills exceeds the preset number condition in the current game. In some examples, when it is detected that there are no less than two second virtual characters, other attributes such as a plurality of second virtual conditions, for example, a damage amount and a healing amount, may be compared according to priorities, to determine a unique virtual character for display, but this constitutes no limitation. Further, other attributes such as a plurality of second virtual conditions, for example, a damage amount and a healing amount, may be compared according to priorities, to determine a display order of a plurality of virtual characters and sequentially display the virtual characters, but this constitutes no limitation.

In some examples, in this embodiment, the virtual projection may include, but is not limited to, the character model projection and the game data projection corresponding to the virtual character. The character model projection may include, but is not limited to, a 3D model material of the virtual projection and a posture projection of the virtual projection. The game data projection may include, but is not limited to, a data type and a data location displayed by the virtual projection.

In some examples, in this embodiment, the virtual projection includes at least one of the following: a character model projection of the second virtual character, a game data projection of the second virtual character, a game data projection of another virtual character participating in the current game task, or the like. In other words, the virtual projection shows a character model projection of a specific virtual character (the second virtual character), but the game data projection may show more diverse game data corresponding to the virtual character, but this constitutes no limitation, for example, dynamically show game data corresponding to the top 10 virtual characters in the current game.

In some examples, in this embodiment, the character model may instruct the player to perform a configuration operation through the first projection configuration interface, but this constitutes no limitation. The configuration operation may instruct the player to set a 3D model material and posture of a to-be-displayed virtual projection in the game, but this constitutes no limitation. A 3D model of the virtual projection corresponding to the projection material may be selected, but this constitutes no limitation. Further, the 3D model posture of the virtual projection may be adjusted to be upright, semi-upright, prone, or the like, but this constitutes no limitation.

In some examples, in this embodiment, the character model projection and the game data projection may change with the triggering of game events such as player attacks and weather changes. For example, when a player A performs a virtual projection display operation and a virtual projection of a player B from another camp is displayed, if the player B is very close to the player A at this time, that is, the player A is in a dangerous scene, in the virtual projection of the player B, the color of the character model projection may be changed to red representing danger and alertness, but this constitutes no limitation. When the distance is no longer a dangerous distance, the normal expression of the character model projection is restored, thereby enriching game play methods in the game to improve player game experience. For another example, if a weather attribute corresponding to a current time of the player A is rain, when the virtual projection of the player B is triggered, the virtual projection of the player B on a rainy day is displayed correspondingly, for example, the rain special effect or rain sound is added.

In some examples, in this embodiment, the game data projection may instruct the player to perform a configuration operation through the second projection configuration interface, but this constitutes no limitation. The configuration operation may include, but is not limited to, setting a display information type and a display information location of the real-time game data. Setting the display information type of the real-time game data may be, but is not limited to, adjusting the data type displayed by the virtual projection, to include one of the following: a number of kills in the game, a healing amount in the game, a number of kills in the last ten games, a game achievement in the last ten games, or the like. Setting the display information location of the real-time game data may be, but is not limited to, adjusting a location of the data type displayed by the virtual projection, and may be, but is not limited to, displaying display information of the real-time game data in sorting manners such as top-down sorting and left-right sorting.

A player does not need to move to a fixed display location to watch the virtual projection during the game. Instead, based on the virtual interactive prop and an autonomous interaction behavior of the player, a virtual projection of the player that changes with the game condition is displayed. By associating the virtual interactive prop with the virtual projection, autonomous display of the virtual projection is achieved through an interactive behavior performed on the virtual interactive prop. Besides, since the autonomous display does not constrain the location of the virtual projection, a player no longer needs to move to a fixed and designated location to view the displayed virtual projection, and instead the player autonomously determines when and where to view the displayed virtual projection, thereby providing the player with an efficient information (virtual projection) display manner and improving information display efficiency, to solve the technical problem of low information display efficiency.

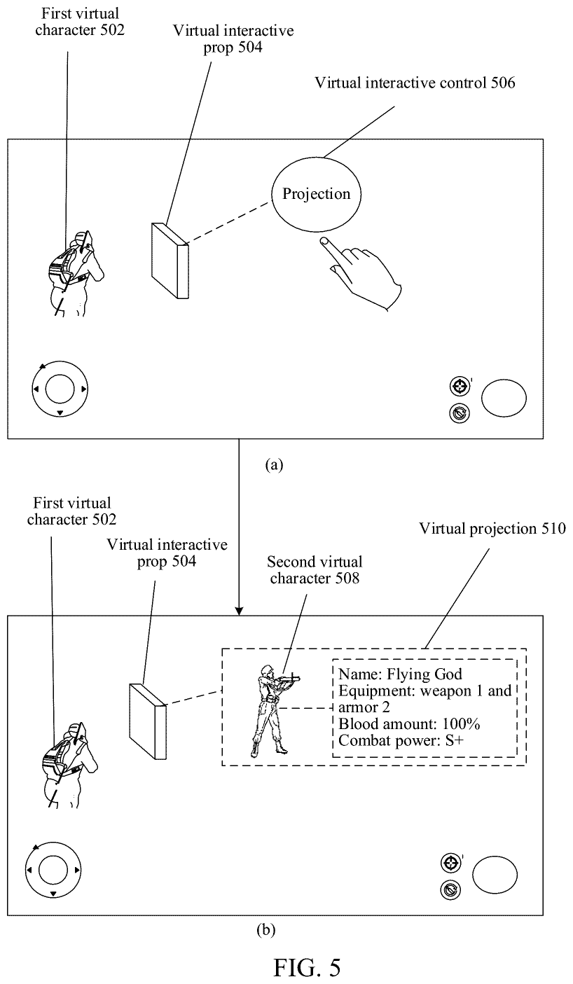

For another example, as shown in (a) of FIG. 5, in a running process of a current game task of the first virtual character 502 controlled by the player, the first virtual character 502 performs a projection display operation by clicking on a virtual interactive control 506 with the word “projection” displayed on a virtual interactive prop 504. In this way, as shown in (b) of FIG. 5, in response to a projection display operation performed on the virtual interactive control 506, a virtual projection 510 corresponding to a second virtual character 508 is displayed, the second virtual character 508 being a virtual character that satisfies a projection condition and that are of virtual characters participating in the current game task, and the virtual projection including at least one of a character model projection of the second virtual character and a game data projection of the second virtual character.

In the embodiments of the present disclosure, in the running process of the first virtual character participating in the current game task, the first virtual character and the virtual interactive prop are displayed. In response to a projection display operation performed on the virtual interactive prop, a virtual projection corresponding to a second virtual character is displayed, the second virtual character being a virtual character that satisfies a projection condition and that are of virtual characters participating in the current game task, and the virtual projection including at least one of a character model projection of the second virtual character and a game data projection of the second virtual character. On a client in which the first virtual character is located, the first virtual character and the virtual interactive prop are displayed. After the projection display operation performed on the virtual interactive prop is detected, the virtual projection corresponding to the second virtual character is displayed on the client. By associating the virtual interactive prop with the virtual projection, autonomous display of the virtual projection is achieved through an interactive behavior performed on the virtual interactive prop. Besides, since the autonomous display does not constrain the location of the virtual projection, a player no longer needs to move to a fixed and designated location to view the displayed virtual projection, and instead the player autonomously determines when and where to view the displayed virtual projection, thereby providing the player with an efficient information (virtual projection) display manner and improving information display efficiency, to solve the technical problem of low information display efficiency.

As a solution, before the displaying, in response to a projection display operation performed on the virtual interactive prop, a virtual projection corresponding to a second virtual character, the method further includes:
S1: Display a projection interactive control corresponding to the virtual interactive prop.
S2: Obtain a triggered projection operation performed on the projection interactive control, and determine the triggered projection operation as the projection display operation.

In some examples, in this embodiment, the virtual interactive prop may be, but is not limited to, a projection apparatus in the game, and may also be, but is not limited to, game equipment with a projection function in the game. For example, the virtual interactive prop may be, but is not limited to, an attack prop with a projection function, a defense armor with a projection function, a treatment package with a projection function, detection equipment with a projection function, and the like.

In some examples, in this embodiment, the virtual interactive prop may include, but is not limited to, a projection interactive control, where the projection interactive control may instruct the first virtual character controlled by the player to interact with the virtual interactive prop, but this constitutes no limitation. In some examples, the projection interactive control may be displayed when the first virtual character controlled by the player and the virtual interactive prop meet a preset condition. The preset condition may be, but is not limited to, that the distance between the first virtual character and the virtual interactive prop is less than or equal to a distance, may be, but is not limited to, that the completion degree of the current game task that the first virtual character participates in is greater than a value, and may be, but is not limited to, that account permission information of the player controlling the first virtual character meets an interaction permission condition. The present disclosure does not impose additional restrictions on a display condition of the projection interactive control.

In this embodiment, the projection interactive control may be used to indicate one or more attribute types included in the virtual interactive prop, but this constitutes no limitation. The attribute types included in the virtual interactive prop may be used to indicate obtaining target game data and indicate determining the virtual projection triggering condition, but this constitutes no limitation. The obtaining a triggering projection operation performed on the projection interactive control may include, but is not limited to, determining an obtaining type of the target game data and a virtual projection triggering condition according to one or more attribute types of the virtual interactive prop indicated by the projection interactive control.

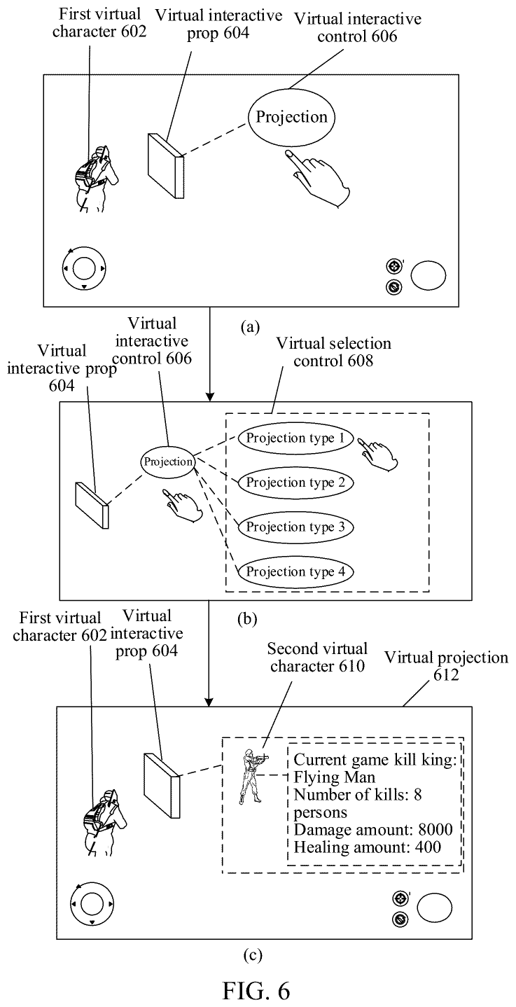

For another example, as shown in (a) of FIG. 6, a first virtual character 602 approaches a virtual interactive prop 604 and performs a projection display operation by clicking on a virtual interactive control 606 with the word “projection” displayed on the virtual interactive prop 604. In this way, as shown in (b) of FIG. 6, in response to the projection display operation performed on the virtual interactive control 606, the virtual selection control 608 is displayed. The virtual selection control 608 may include, but is not limited to, a plurality of projection type options, and may indicate a plurality of attribute types included in the virtual interactive props 604. A projection type 1 may be used to indicate a virtual object projection with the highest cumulative number of kills participating in the current game task. A projection type 2 may be used to indicate a virtual object projection with the highest cumulative healing amount participating in the current game task. A projection type 3 may be used to indicate a virtual projection object with the highest number of career kills participating in the target virtual game. A projection type 4 may be used to indicate a virtual object projection with the highest average number of kills participating in a plurality of game tasks in the target virtual game. A projection selection operation is performed on the first virtual character 602, and a virtual object projection with the highest cumulative number of kills participating in the current game task is selected and obtained. As shown in (c) in FIG. 6, the virtual projection 612 corresponding to the second virtual character 610 is displayed on the client in which the first virtual character 602 is located. The virtual projection 612 includes the 3D model and the real-time game data “the current game kill king: Flying Man, number of kills: 8 persons, damage amount: 8000, and healing amount: 400” of the second virtual character 610. Based on this, the first virtual character 602 obtains the information that the second virtual character 610 named Flying Man is the virtual character with the highest number of kills in the current game, the 3D display model of the virtual character, and other game information of the virtual character in the game.

In this embodiment of this disclosure, the projection interactive control corresponding to the virtual interactive prop is displayed. A triggered projection operation performed on the projection interactive control is obtained, and the triggered projection operation is determined as the projection display operation.

As a solution, the displaying a projection interactive control corresponding to the virtual interactive prop includes:
S1: When a distance between the first virtual character and the virtual interactive prop is less than or equal to a first threshold, display the projection interactive control.

In some examples, in this embodiment, to improve the display flexibility of the projection interactive control, a display location, a display style, a display duration, and the like of the projection interactive control may be set by the player autonomously, but this constitutes no limitation. For example, it is preset that the projection interactive control is displayed in the middle of the display screen of the client, and the size and transparency thereof may be all pre-configured. By presetting the display duration, the projection interactive control is automatically hidden after the display duration is reached. In addition, a virtual resource may also be used to exchange for more diverse display styles of the virtual interactive control, but this constitutes no limitation, thereby improving user experience.

In some examples, in this embodiment, the virtual interactive prop may be, but is not limited to, game props with a projection function generated at various preset data display points in the game at the beginning of the game. The data display point may be, but is not limited to, a virtual safety scene whose safety value is not lower than a threshold in the current game task.

When the first virtual character controlled by the player is close to the data display point in which the virtual interactive prop is placed, the player may interact with the projection interactive control corresponding to the virtual interactive prop. For example, when the first virtual character controlled by the player is close to the virtual interactive prop, an interaction button is displayed, and the word “projection” is displayed on the button. The player may click on the button to perform the projection triggering operation.

In some examples, in this embodiment, the projection interactive prop corresponding to the virtual interactive prop may display the projection interactive control when the distance between the first virtual character and the virtual interactive prop is less than or equal to a first threshold, but this constitutes no limitation. The first threshold may be, but is not limited to, a preset location distance used in the game to determine that the first virtual character and the virtual interactive prop may interact.

The condition of the first threshold is set, so that the projection interactive control corresponding to the virtual interactive prop is displayed only when the distance between the first virtual character and the virtual interactive prop is not greater than the first threshold. In this way, a player does not easily and passively receive the projection interactive control of the virtual interactive prop in the game, to ensure that the player actively controls the first virtual character to interact with the virtual interactive prop and improve player game experience in the game.

In this embodiment of this disclosure, the projection interactive control is displayed when the distance between the first virtual character and the virtual interactive prop is less than or equal to the first threshold. In this way, a player does not easily and passively receive the projection interactive control of the virtual interactive prop in the game, to ensure that the player actively controls the first virtual character to interact with the virtual interactive prop and improve player game experience in the game.

As a solution, the displaying the first virtual character and a virtual interactive prop includes:
S1: Display the first virtual character located in a virtual safety scene and the virtual interactive prop located in the virtual safety scene, where the virtual safety scene is a virtual scene whose safety value is greater than or equal to a second threshold in the current game task.

In some examples, in this embodiment, the virtual interactive prop may be preset in the virtual safety scene at the beginning of the game, but this constitutes no limitation. The virtual safety scene may be, but is not limited to, a virtual scene whose safety value is greater than or equal to a second threshold in the current game task. In the game, there is fierce competition and confrontation between players from different camps. Therefore, to ensure the safety of the player when controlling the first virtual character to interact with the virtual interactive prop to obtain the projection information of the second virtual character, the virtual safety scene may be, but is not limited to, a virtual scene whose safety value is greater than or equal to the second threshold in the current game task. The safety value may change according to the actual game condition, but this constitutes no limitation.

In some examples, in this embodiment, the virtual safety scene may also be, but is not limited to, a safe house set in the current game task. The safe house may be, but is not limited to, an absolutely safe area in the game. It may be set in the game that the number of virtual characters allowed to enter the safe house is less than or equal to a third threshold, but this constitutes no limitation. It may be set that a virtual character allowed to enter the safe house is in an unselectable state, but this constitutes no limitation. The virtual character in the unselectable state will not be injured by attacks from other virtual characters, and at the same time, cannot attack other virtual characters. It may also be set that a time of the unselectable state of the virtual character in the safe house is less than or equal to a fourth threshold, but this constitutes no limitation, to prevent that the virtual character controlled by the player always stays in the safe house, which destroys the balance of the game and thus affects game experience of other players.

The virtual interactive prop is placed in the virtual safety scene to ensure the safety of the player when controlling the first virtual character to interact with the virtual interactive prop. In a virtual safety scene of the safe house, by setting an unselectable state in a period of time for the virtual character entering the safe house, the safety of the interaction between the first virtual character and the virtual interactive prop is fully ensured while preventing that the player takes advantage of the unselectable or absolutely safe state to destroy game balance.

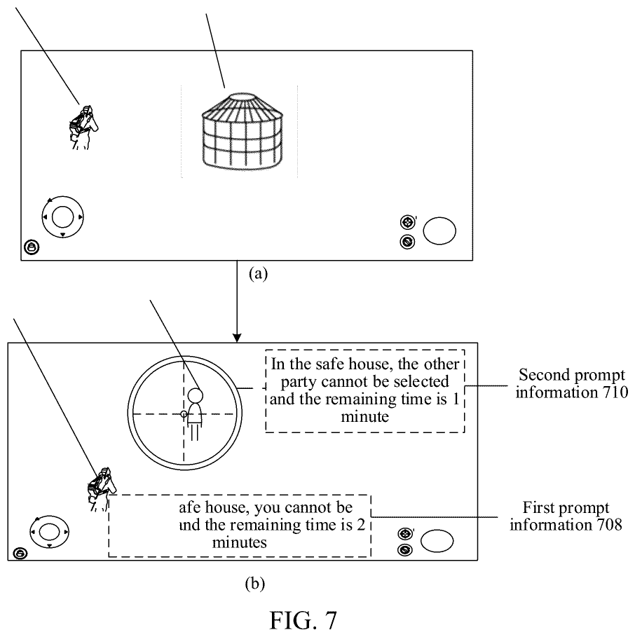

For another example, as shown in (a) of FIG. 7, a first virtual character 702 discovers a safe house 704 while participating in the current game task. The safe house 704 serves as an absolutely safe space in the game, and a virtual character in the safe house is in an unselectable state. The virtual character in the unselectable state will not be injured by attacks from other virtual characters, and at the same time, cannot attack other virtual characters. The safe house 704 may accommodate a limited number of virtual characters, and each virtual character is allowed to stay for a limited time period. After the first virtual character 702 enters the safe house 704, as shown in (b) of FIG. 7, a client in which the first virtual character 702 is located immediately displays first prompt information 708 “you are in an unselectable state in the safe house and the remaining time is 2 minutes”. When the first virtual character 702 discovers a third virtual character 706 of another camp in the safe house 704, and the first virtual character 702 starts an attack prop and prepares to attack the third virtual character 706, the client in which the first virtual character 702 is located displays second prompt information 710 “the other party is in an unselectable state in the safe house and the remaining time is 1 minute”.

In this embodiment of this disclosure, the first virtual character located in a virtual safety scene and the virtual interactive prop located in the virtual safety scene are displayed, where the virtual safety scene is a virtual scene whose safety value is greater than or equal to a second threshold in the current game task, to ensure the safety of the player when controlling the first virtual character to interact with the virtual interactive prop to obtain the projection information of the second virtual character, thereby improving player game experience.

As a solution, the displaying a virtual projection corresponding to the second virtual character includes:
S1: Display the virtual projection on a target client, where the target client is a game client corresponding to the first virtual character, the virtual projection is prohibited from being displayed on any one of game clients other than the target client, and the game client is a client corresponding to the virtual character participating in the current game task.

In some examples, in this embodiment, the first virtual character and the virtual interactive prop are displayed on the target client corresponding to the first virtual character, and in response to the projection display operation performed on the virtual interactive prop, the target client displays the virtual projection corresponding to the second virtual character. The virtual projection may be prohibited from being displayed on other clients other than the target client, but this constitutes no limitation. The virtual projection may also include, but is not limited to, a 3D model projection and a real-time game data display that are only visible to the player.

The displayed virtual projection corresponding to the second virtual character is only visible to the player who performs the corresponding projection triggering operation. Through the autonomous interaction behavior of the player, a player 3D model projection and real-time game data information that change with the game condition and are visible only to the player are displayed. Compared with solutions in traditional shooting games, the player 3D model projection and real-time data are displayed in the game with low memory usage, greatly reducing performance pressure and optimizing player game experience.

In some examples, in this embodiment, the first virtual character and the virtual interactive prop are displayed on the target client corresponding to the first virtual character, and in response to the projection display operation performed on the virtual interactive prop, the target client displays the virtual projection corresponding to the second virtual character. The virtual projection may include a 3D model projection and a real-time game data display that are only visible to the player, but this constitutes no limitation. The virtual projection may also display other clients that have a target relationship with the target client. The target relationship may be used to indicate whether the first virtual character displayed on the target client and virtual characters of other clients are in the same camp in the current game task, but this constitutes no limitation.

In some examples, in this embodiment, displaying the virtual projection on other clients that have a target relationship with the target client may be, but is not limited to: after the first virtual character displayed on the target client performs a projection sharing operation, displaying the virtual projection on other clients that have a target relationship with the target client. The projection sharing operation may include, but is not limited to, that the first virtual character long-presses to select a to-be-shared virtual projection, and select one or more sharing clients from other clients that have a target relationship with the target client.

The displayed virtual projection corresponding to the second virtual character is not only visible to the player who performs the corresponding projection triggering operation, but also may display the player 3D model projection and game real-time data information that change with the game condition to players (teammates) in the same camp as the player through the projection sharing behavior of the player. Compared with solutions in traditional shooting games, the player 3D model projection and real-time data may be shared in the game on clients of players in the same camp with low memory usage, and players in the same camp do not need to separately control virtual objects and virtual interactive props to perform interactive operations to obtain virtual projection information, greatly reducing performance pressure, improving player information obtaining efficiency, and optimizing player game experience.

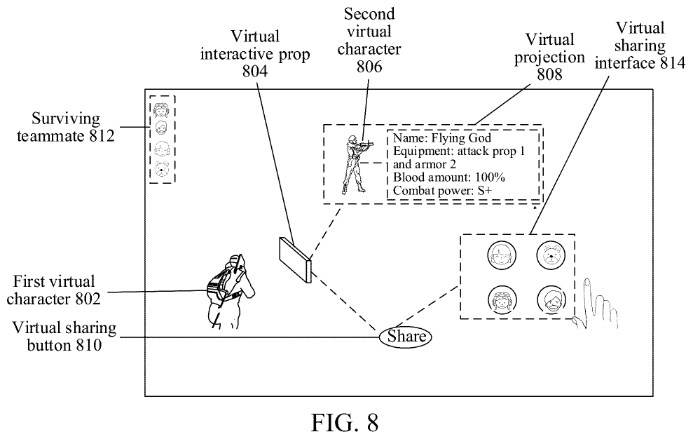

For another example, as shown in FIG. 8, a first virtual character 802 performs an interactive operation with a virtual interactive prop 804, so that a client in which the first virtual character 802 is located displays a virtual projection 808 corresponding to a second virtual character 806. The first virtual character 802 may long-press the virtual interactive prop 804 to display a virtual sharing button 810, but this constitutes no limitation. In response to a click operation of the first virtual character 802 on the virtual sharing button 810, a to-be-shared surviving teammate 812 is further displayed. When the first virtual character 802 selects the to-be-shared object on the virtual sharing interface 814 to perform a virtual projection sharing operation, the client in which the shared object is located correspondingly displays the virtual projection 808 shared by the first virtual character 802.

In this embodiment of this disclosure, the virtual projection is displayed on a target client, where the target client is a game client corresponding to the first virtual character, the virtual projection is prohibited from being displayed on any one of game clients other than the target client, and the game client is a client corresponding to the virtual character participating in the current game task. Through the autonomous interaction behavior of the player, a player 3D model projection and real-time game data information that change with the game condition and are visible only to the player are displayed. The player 3D model projection and real-time data are displayed in the game with low memory usage, greatly reducing performance pressure and optimizing player game experience.

As a solution, after displaying the virtual projection on the target client, the method further includes:
S1: When a display duration of the virtual projection is greater than or equal to a preset threshold, cancel the display of the virtual projection, and delete display data corresponding to the virtual projection from the target client.

In some examples, in this embodiment, display of the virtual projection may be cancelled when the display duration on the target client is not less than a preset threshold, but this constitutes no limitation. Display data corresponding to the virtual projection may be deleted from the target client while cancelling (or stopping) the display, but this constitutes no limitation. Further, the display data corresponding to the virtual projection in the target client is reserved in a cache area for a period of time while cancelling the display, but this constitutes no limitation, and then the display data corresponding to the virtual projection is deleted from the target client when no repeated projection display operation is triggered within a period of time.

In some examples, in this embodiment, the display data may be understood as a lower-level data concept, while the game data may be understood as a data concept embodied in content, but this constitutes no limitation. The display data and the game data may be understood as that the target client displays the model projection and the game data through the display data, or in other words, before the target client displays the model projection and the game data through the display data, the corresponding display data needs to be obtained first, and then the model projection and the game data are displayed.

When the display duration of the virtual projection on the target client reaches the preset threshold, the display is automatically cancelled. Besides, after the display is cancelled, the display data corresponding to the virtual projection in the target client may be deleted simultaneously, thereby further reducing the data memory usage in the game to greatly reduce performance pressure.

When the display duration of the virtual projection on the target client reaches the preset threshold, the display is automatically cancelled. Besides, after the display is cancelled, the display data corresponding to the virtual projection in the target client is reserved in the cache area for a period of time, and the display data corresponding to the virtual projection is deleted from the target client when no repeated projection display operation is triggered within a period of time, thereby improving the efficiency of obtaining the display data of the virtual projection and improving the display efficiency of the virtual projection.

In some examples, in this embodiment, display of the virtual projection may be cancelled when the virtual interactive prop is located in a virtual dangerous scene, but this constitutes no limitation. Display data corresponding to the virtual projection may be deleted from the target client while cancelling the display, but this constitutes no limitation. Further, the display data corresponding to the virtual projection in the target client is reserved in a cache area for a period of time while cancelling the display, but this constitutes no limitation, and then the display data corresponding to the virtual projection is deleted from the target client when no repeated projection display operation is triggered within a period of time. The virtual dangerous scene is a virtual scene in which the safety value in the current game task is less than the fifth threshold, and the value of the fifth threshold is less than the value of the second threshold.

The virtual projection may be visible only on the target client in which the player is located, but this constitutes no limitation. In this case, the virtual projection does not expose location information of the first virtual character to other players. However, when the first virtual character is in a virtual dangerous scene, the player does not pay too much attention to the virtual projection, and instead focuses on the game combat in the current virtual dangerous scene. Therefore, display of the virtual projection may be automatically cancelled when the virtual interactive prop is in a virtual dangerous scene, thereby improving user game experience.

In this embodiment of this disclosure, when a display duration of the virtual projection is greater than or equal to a preset threshold, the display of the virtual projection is cancelled, and display data corresponding to the virtual projection is deleted from the target client, thereby reducing data memory usage in the server and greatly reducing performance pressure.

As a solution, after cancelling the display of the virtual projection and deleting the display data corresponding to the virtual projection from the target client, the method further includes:
S1: Obtain the display data in response to the projection display operation.
S2: Display the virtual projection based on the display data, to display the virtual projection on the target client.

In some examples, in this embodiment, display of the virtual projection may be cancelled when the display duration on the target client is not less than the preset threshold, but this constitutes no limitation. The display data corresponding to the virtual projection may be deleted from the target client while cancelling the display, but this constitutes no limitation. Further, shortly after display of the virtual projection is cancelled, the player controls the first virtual character to interact with the virtual interactive prop again, in response to the projection display operation, the display data corresponding to the virtual projection is obtained again, and the virtual projection is displayed based on the display data, to display the virtual projection again on the target client, but this constitutes no limitation.

When the display duration of the virtual projection on the target client reaches the preset threshold, the display is automatically cancelled. Besides, after the display is cancelled, the display data corresponding to the virtual projection in the target client may be deleted simultaneously, but this constitutes no limitation, and the corresponding display data may be obtained again in response to the projection display operation again, thereby further reducing the data memory usage in the game to greatly reduce performance pressure.

In some examples, in this embodiment, display of the virtual projection may be cancelled when the display duration on the target client is not less than a preset threshold, but this constitutes no limitation. Display data corresponding to the virtual projection may be deleted from the target client while cancelling the display, but this constitutes no limitation. Further, the display data corresponding to the virtual projection in the target client is reserved in a cache area for a period of time while cancelling the display, but this constitutes no limitation, and when the projection display operation is received again within a period of time, the corresponding display data is directly pulled from the cache area and the virtual projection is displayed based on the display data to display the virtual projection on the target client.

Display of the virtual projection is automatically cancelled when the display time on the target client reaches the preset threshold. After the display is cancelled, the display data corresponding to the virtual projection in the target client may be reserved in the cache area for a period of time, and when the projection display operation is received again within a period of time, the corresponding display data is directly pulled from the cache area and the virtual projection is displayed based on the display data to display the virtual projection on the target client, thereby reducing the time of repeated virtual projection display within a period of time and improving the display efficiency of the virtual projection.

As a solution, before the displaying, in response to a projection display operation performed on the virtual interactive prop, a virtual projection corresponding to a second virtual character, the method further includes:
S1: In response to a prop pickup operation performed on the virtual interactive prop, place the virtual interactive prop in a virtual storage space associated with the first virtual character.

In some examples, in this embodiment, the virtual interactive prop may be, but is not limited to, game props that may be held movably and used at any time. The first virtual character may pick up and place the prop in a virtual storage space associated with the first virtual character, but this constitutes no limitation. The virtual storage space associated with the first virtual character may be, but is not limited to, a container prop carried by the first virtual character when participating in the current game task, but this constitutes no limitation. A number of game prop resources may be provided for the first virtual character, but this constitutes no limitation. The game prop resource may include, but is not limited to, attack props, defensive armors, treatment packages, virtual interactive props, and the like.

The virtual interactive prop may be, but is not limited to, an attack prop with a projection function, a defense armor with a projection function, a treatment package with a projection function, detection equipment with a projection function, and the like. A player may control the first virtual character to movably hold a virtual interactive prop, but this constitutes no limitation, may pick up and place the prop in the virtual storage space associated with the first virtual character, but this constitutes no limitation, and may take out the virtual interactive prop from the virtual storage space for usage at any time, to obtain key information of the second virtual character, but this constitutes no limitation.

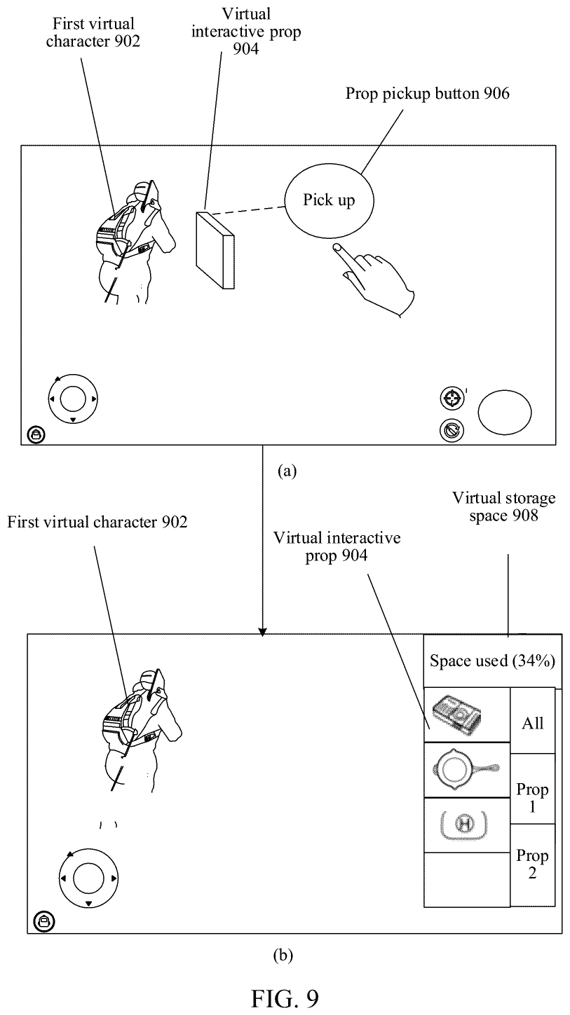

For another example, as shown in (a) of FIG. 9, a first virtual character 902 and a virtual interactive prop 904 are displayed on a client in which the first virtual character 902 is located. When the first virtual character 902 performs a prop pickup operation on a virtual pickup button 906, as shown in (b) of FIG. 9, when the available space of a virtual storage space 908 associated with the first virtual character 902 is sufficient to store the virtual interactive prop 904, the virtual interactive prop 904 is placed in the virtual storage space 908.

In this embodiment of this disclosure, in response to the prop pickup operation performed on the virtual interactive prop, the virtual interactive prop is placed in the virtual storage space associated with the first virtual character, and the player may pick up the virtual interactive prop and store the prop in the virtual storage space as a strategic game prop in the process of participating in the current game task, thereby improving the flexibility of using the virtual interactive prop and improving the display efficiency of the virtual projection.

As a solution, after the placing, in response to a prop pickup operation performed on the virtual interactive prop, the virtual interactive prop in a virtual storage space associated with the first virtual character, the method further includes:
S1: In response to a first usage operation performed on the virtual interactive prop placed in the virtual storage space, display the virtual projection; or
S2: In response to a holding triggering operation performed on the virtual interactive prop placed in the virtual storage space, adjust a state of the virtual interactive prop from a storage state to a holding state, where the state of the virtual interactive prop placed in the virtual storage space is the storage state; and display the virtual projection in response to a second usage operation performed on the virtual interactive prop in the holding state; or
S3: In response to a triggering of a drop operation performed on the virtual interactive prop placed in the virtual storage space, adjust a state of the virtual interactive prop from the storage state to an unowned state, where the state of the virtual interactive prop not owned by the first virtual character is the unowned state; and display the virtual projection in response to a third usage operation performed on the virtual interactive prop in the unowned state.

In some examples, in this embodiment, the first usage operation may be used to instruct the virtual character to perform an operation of displaying a virtual projection on the virtual interactive prop in a storage state. The second usage operation may be used to instruct the virtual character to perform the operation of displaying a virtual projection on the virtual interactive prop in a holding state. The third usage operation may be used to instruct the virtual character to perform the operation of displaying a virtual projection on a virtual interactive prop in an unowned state. The storage state of the virtual interactive prop may be, but is not limited to, a state of placing the virtual interactive prop in the virtual storage space in response to the prop pickup operation. The holding state of the virtual interactive prop may be, but is not limited to, a state of adjusting, in response to a holding triggering operation performed on the virtual interactive prop, the virtual interactive prop to a state of being held by the virtual character. The unowned state of the virtual interactive prop may be, but is not limited to, a state of discarding the virtual interactive prop from the virtual storage space in response to a triggering of a drop operation performed by the virtual interactive prop.

When the virtual character participates in the current game task, in addition to directly performing an interactive operation on the virtual interactive prop to display a virtual projection that meets a condition, the virtual character may also carry the virtual interactive prop by holding the virtual interactive prop or storing the virtual interactive prop in the virtual storage space. For example, when the player controls the first virtual character to perform an interactive operation with the virtual interactive prop, a combat signal appears nearby. In such a virtual dangerous scene, the first virtual character controlled by the player may pick up the virtual interactive prop to the storage space or leave the current virtual dangerous scene in time when holding the virtual interactive prop.

When the capacity of the virtual storage space is insufficient, the first virtual character controlled by the player may discard the virtual interactive prop in the current game environment in response to a triggering of a drop operation. The first virtual character may expose the discarded unowned virtual interactive prop in the game environment in the form of “bait”, so that the first virtual character may adopt corresponding ambush or other strategies. In this way, game play methods are increased and the fun of the game is improved, thereby improving player game experience.

In this embodiment of this disclosure, in response to a first usage operation performed on the virtual interactive prop placed in the virtual storage space, the virtual projection is displayed; or in response to a holding triggering operation performed on the virtual interactive prop placed in the virtual storage space, a state of the virtual interactive prop is adjusted from a storage state to a holding state, where the state of the virtual interactive prop placed in the virtual storage space is the storage state; and the virtual projection is displayed in response to a second usage operation performed on the virtual interactive prop in the holding state; or in response to a triggering of a drop operation performed on the virtual interactive prop placed in the virtual storage space, a state of the virtual interactive prop is adjusted from the storage state to an unowned state, where the state of the virtual interactive prop not owned by the first virtual character is the unowned state; and the virtual projection is displayed in response to a third usage operation performed on the virtual interactive prop in the unowned state. By providing players with a variety of operating methods for using virtual interactive props, game play methods are increased and the fun of the game is improved, thereby improving player game experience.

As a solution, before the displaying, in response to a projection display operation performed on the virtual interactive prop, a virtual projection corresponding to a second virtual character, the method further includes:
S1: Display a first projection configuration interface, where a plurality of projection character templates are displayed on the first projection configuration interface, and projection materials corresponding to the plurality of projection character templates are different.
S2: In response to a selection operation performed on a target projection template of the plurality of projection character templates, display a second projection configuration interface corresponding to the target projection template.
S3: In response to a configuration operation triggered on the second projection configuration interface, configure a display parameter of the target projection template, where the display parameter is configured for determining a display location of a projection element on a virtual projection matching the target projection template.

In some examples, in this embodiment, the first projection configuration interface may, but is not limited to, instruct the player to perform a configuration operation on a to-be-displayed virtual projection in the game before the game begins. The virtual projection may include, but is not limited to, the 3D model projection and the real-time game data projection corresponding to the virtual character. The configuration operation may, but is not limited to, instruct the player to set a projection material of the 3D model of the to-be-displayed virtual projection in the game.

In some examples, in this embodiment, the second projection configuration interface may be, but is not limited to, a configuration interface corresponding to the selected target projection template after the player selects the target projection template in the first projection configuration interface. The player may be provided with a configuration operation performed on the selected target projection template. The configuration operation may include, but is not limited to, setting a model posture of a projection character template, a display information type of real-time game data, a display information location, and the like. The setting the model posture of the projection character template may be, but is not limited to, adjusting the 3D model posture of the virtual projection to be upright, semi-upright, prone, or the like. The setting the display information type of the real-time game data may be, but is not limited to, adjusting the data type displayed by the virtual projection, to include one of the following: a number of kills in the game, a healing amount in the game, a number of kills in the last ten games, a game achievement in the last ten games, or the like. The setting the display information location of the real-time game data may be, but is not limited to, adjusting a location of the data type displayed by the virtual projection, and may be, but is not limited to, displaying display information of the real-time game data in sorting manners such as top-down sorting and left-right sorting.

In some examples, in this embodiment, in response to a configuration operation triggered on the second projection configuration interface, a display parameter of the target projection template is configured, where the display parameter is configured for determining a display location of a projection element on a virtual projection matching the target projection template. The projection element may include, but is not limited to, the 3D model posture of the virtual projection, a data type displayed by the virtual projection, a data location displayed by the virtual projection, and the like.

The first projection configuration interface displays a plurality of projection character templates, and the plurality of projection character templates correspond to different projection materials. The second projection configuration interface further provides a configuration operation for a plurality of parameter information executable on the selected projection character template. Players may select the projection character template corresponding to a specific projection material according to their own preferences, and further adjust the 3D model posture and real-time data display method of the virtual projection in the game, thereby better diversifying virtual projection display of the player in the game and improving player game experience.

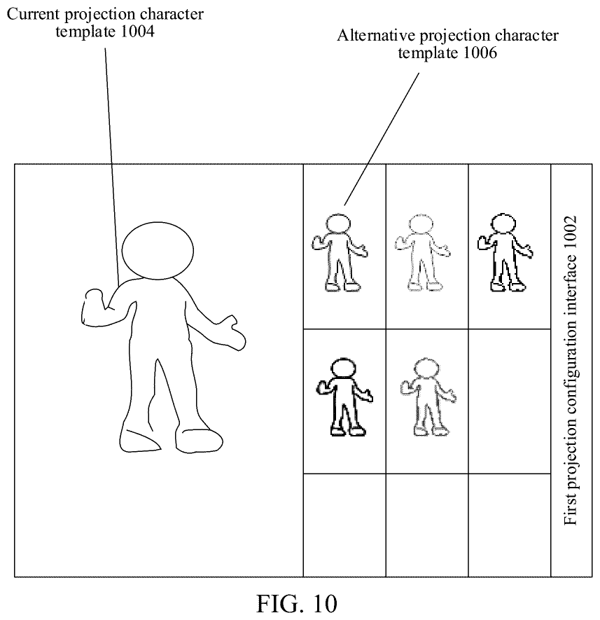

For another example, as shown in FIG. 10, a first projection configuration interface 1002 displays a selected current projection character template 1004 and a plurality of alternative projection character templates 1006, where different alternative character templates correspond to different character materials. The current projection character template 1004 changes accordingly as the player selects the alternative projection template 1006.

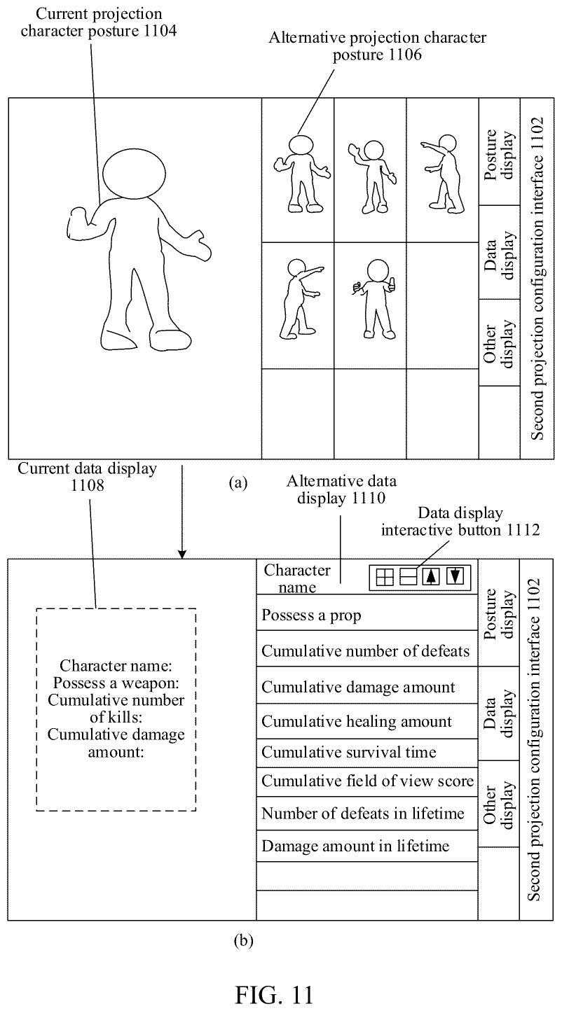

For another example, as shown in (a) of FIG. 11, a second projection configuration interface 1102 displays a selected current projection character posture 1104 and a plurality of alternative projection character postures 1106, where different alternative character templates correspond to the same character material and different character postures. The current projection character posture 1104 changes as the player selects the alternative projection character posture 1106. As shown in (b) of FIG. 11, the second projection configuration interface 1102 displays a selected current data presentation 1108, a plurality of alternative data presentations 1110, and a data presentation interaction button 1112 corresponding to each alternative data presentation. The player uses the data presentation interaction button 1112 to add, delete, move up in order, move down in order, and perform other operations on the alternative data presentation 1110, and then the current data presentation 1108 changes as the player selects the alternative data presentation 1110.

In this embodiment of this disclosure, a first projection configuration interface is displayed, where a plurality of projection character templates are displayed on the first projection configuration interface, and projection materials corresponding to the plurality of projection character templates are different; in response to a selection operation performed on a target projection template of the plurality of projection character templates, a second projection configuration interface corresponding to the target projection template is displayed; and in response to a configuration operation triggered on the second projection configuration interface, a display parameter of the target projection template is configured, where the display parameter is configured for determining a display location of a projection element on a virtual projection matching the target projection template. Players may select the projection character template corresponding to a specific projection material according to their own preferences, and further adjust the 3D model posture and real-time data display method of the virtual projection in the game, thereby better diversifying virtual projection display of the player in the game and improving player game experience.

As a solution, the displaying, in response to a projection display operation performed on the virtual interactive prop, a virtual projection corresponding to a second virtual character includes:
S1: In response to the projection display operation, obtain N virtual characters participating in the current game task, where N is a natural number greater than or equal to 2.
S2: Obtain target game data corresponding to each of the N virtual characters.
S3: Determine a target virtual character whose target game data satisfies the projection condition from the N virtual characters, and determine the target virtual character as the second virtual character.
S4: Display the virtual projection.

In some examples, in this embodiment, in response to the projection display operation, N virtual characters participating in the current game task are obtained, where Nis a natural number greater than or equal to 2. Target game data corresponding to each of the N virtual characters is obtained. A target virtual character whose target game data satisfies the projection condition is determined from the N virtual characters, and the target virtual character is determined as the second virtual character. The virtual projection is displayed. The target game data may include, but is not limited to, one or more of a cumulative number of kills, a damage amount, and a healing amount of the virtual character in the current game.

In some examples, in this embodiment, virtual interactive props may be, but are not limited to, game props of one or more different attribute types. In some examples, virtual interactive props of different attribute types correspond to different projection conditions. For example, the virtual interactive prop may be used to indicate a virtual character (“killing king”) with the largest number of kills in the current game, but this constitutes no limitation. The corresponding projection condition is the largest number of kills in the current game. The corresponding second virtual character is a virtual character with the largest number of kills in the current game. The virtual interactive prop may be used to indicate a virtual character (“killing king”) whose number of kills exceeds a preset number condition in the current game, but this constitutes no limitation. The corresponding projection condition is that the number of kills is greater than a preset number condition in the current game. The corresponding second virtual character is one or more of a plurality of virtual characters whose number of kills exceeds the preset number condition in the current game. In some examples, when it is detected that there are no less than two second virtual characters, other attributes such as a plurality of second virtual conditions, for example, a damage amount and a healing amount, may be compared according to priorities, to determine a unique virtual character for display, but this constitutes no limitation. Further, other attributes such as a plurality of second virtual conditions, for example, a damage amount and a healing amount, may be compared according to priorities, to determine a display order of a plurality of virtual characters and sequentially display the virtual characters, but this constitutes no limitation.

After the player performs the projection display operation of interacting with the virtual interactive prop, the target virtual character is determined from at least two virtual characters in the current game of the player. The target virtual character is a virtual character whose target game data satisfies a projection condition. The target game data may be one data type, such as a cumulative number of kills in a game, or a plurality of data types, such as a cumulative number of kills and a cumulative damage amount in a game.

In a game, when there is more than one virtual characters whose target game data meets the projection condition, other data types in the target game data of the plurality of virtual characters are compared to determine the unique target virtual character, but this constitutes no limitation. In response to the projection display operation, the unique target virtual character is determined based on the target game data and projection condition, to reduce the memory usage of the virtual projection display and improve the display efficiency of the virtual projection.

For another example, in a game, the target game data may include, but is not limited to, a cumulative number of kills, a cumulative damage amount, and a cumulative healing amount in the game. The projection condition may be, but is not limited to, that the cumulative number of kills in the game exceeds 10. Current surviving game players are a player A, a player B, a player C, and a player D. A cumulative number of kills of a virtual character a controlled by the player A is 5, a cumulative damage amount is 1000, and a cumulative healing amount is 500 in the current game. A cumulative number of kills of a virtual character b controlled by the player B is 11, a cumulative damage amount is 1200, and a cumulative healing amount is 400 in the current game. A cumulative number of kills of a virtual character c controlled by the player C is 11, a cumulative damage amount is 800, and a cumulative healing amount is 500 in the current game. A cumulative number of kills of a virtual character d controlled by the player D is 10, a cumulative damage amount is 1000, and a cumulative healing amount is 300 in the current game. After the virtual character a performs a projection display operation on the virtual interactive prop, the virtual characters whose target game data satisfies the projection condition include the virtual character b and the virtual character c. Further, other data types in the target game data other than the projection condition may be compared to determine the unique target virtual character, but this constitutes no limitation. For example, when the priority of the cumulative damage amount is higher than that of the cumulative healing amount, since the cumulative damage amount of the virtual character b is higher than that of the virtual character c, the virtual character b is determined as the target virtual object from the virtual character b and the virtual character c. When the priority of the cumulative healing amount is higher than that of the cumulative damage amount, since the cumulative damage amount of the virtual character b is lower than that of the virtual character c, the virtual character c is determined as the target virtual object from the virtual character b and the virtual character c.

In this embodiment of this disclosure, in response to the projection display operation, N virtual characters participating in the current game task are obtained, where N is a natural number greater than or equal to 2. Target game data corresponding to each of the N virtual characters is obtained. A target virtual character whose target game data satisfies the projection condition is determined from the N virtual characters, and the target virtual character is determined as the second virtual character. The virtual projection is displayed.

As a solution, the obtaining target game data corresponding to each of the N virtual characters includes at least one of the following:

S1: Obtain first game data corresponding to each of the N virtual characters, where the first game data is real-time game data of each of the N virtual characters participating in the current game task.

S2: Obtain second game data corresponding to each of the N virtual characters, where the second game data is game data of each of the N virtual characters participating in a target virtual game, and the current game task is a game task in the target virtual game.

S3: Obtain third game data corresponding to each of the N virtual characters, where the third game data is game data of each of the N virtual characters participating in a plurality of game tasks in the target virtual game.

In some examples, in this embodiment, the target game data may include, but is not limited to, the real-time game data of the virtual character participating in the current game task. The real-time game data of the current game task may include, but is not limited to, a cumulative number of kills, a cumulative damage amount, a cumulative healing amount, a cumulative field of view score, and the like during participation of the virtual character in the current game task.

The target game data may include, but is not limited to, game data of the virtual object participating in the target virtual game. The current game task that the virtual character participates in may be, but is not limited to, a game in the target virtual game. Game data of the virtual object participating in the target virtual game may include, but is not limited to, a cumulative number of kills, a cumulative damage amount, a cumulative healing amount, a cumulative field of view score, cumulative achievements, a cumulative game length, and the like during participation of the virtual character in the target virtual game.

The target game data may also include, but is not limited to, game data of the virtual object participating in a plurality of game tasks in the target virtual game. The game task may be, but is not limited to, a game task that the virtual object continuously participates in. The game data of the plurality of game tasks may be, but is not limited to, an average number of kills, an average damage amount, an average healing amount, an average field of view score, and the like during participation of the virtual object in the plurality of game tasks.

The target game data not only may be local real-time data of the current game, but also may be historical data of a plurality of games of the player and overall career game data of the player. In the game, types of the target game data may include a plurality of types, and corresponding projection conditions may include a plurality of types. Players may obtain opportunities for virtual projection display in a plurality of manners, thereby better diversifying virtual projection display and enriching player game experience.

In this embodiment of this disclosure, first game data corresponding to each of the N virtual characters is obtained, where the first game data is real-time game data of each of the N virtual characters participating in the current game task. Second game data corresponding to each of the N virtual characters is obtained, where the second game data is game data of each of the N virtual characters participating in a target virtual game, and the current game task is a game task in the target virtual game. Third game data corresponding to each of the N virtual characters is obtained, where the third game data is game data of each of the N virtual characters participating in a plurality of game tasks in the target virtual game. Based on a plurality of types of the target game data, players may obtain opportunities for virtual projection display in a plurality of manners, thereby better diversifying virtual projection display and enriching player game experience.

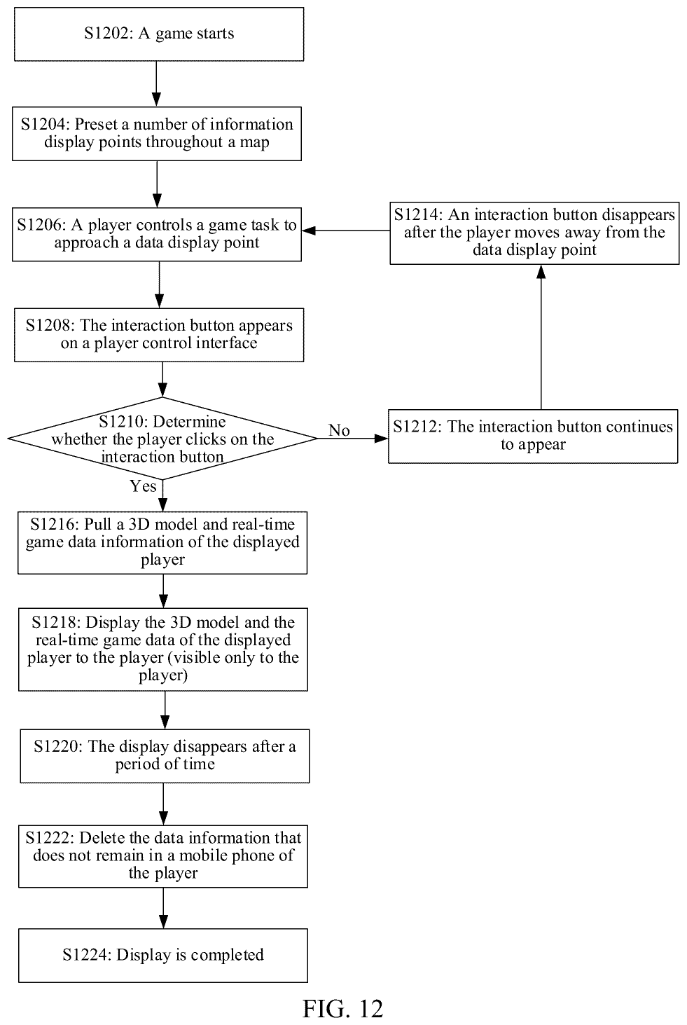

As a solution, the information display method is applied to a virtual shooting game scene, for example, as shown in FIG. 12. The specific operations are as follows:
Operation S1202: A game starts.
Operation S1204: Preset a number of information display points in a map, where the information display point may be used to display a virtual interactive prop, but this constitutes no limitation.
Operation S1206: A player controls a game character to approach the data display point, where the game character is a first virtual character.
Operation S1208: An interaction button appears on a player control interface.
Operation S1210: Determine whether the player clicks on the interaction button.
Operation S1212: The interaction button continues to appear.
Operation S1214: The interaction button disappears after the player moves away from the data display point.
Operation S1216: Pull a 3D model and real-time game data information of the displayed player.
Operation S1218: Display the 3D model and the real-time game data of the displayed player to the player (visible only to the player).
Operation S1220: The display disappears after a period of time.
Operation S1222: Delete the data information so that the information does not remain in a mobile phone of the player.
Operation S1224: Display is completed.

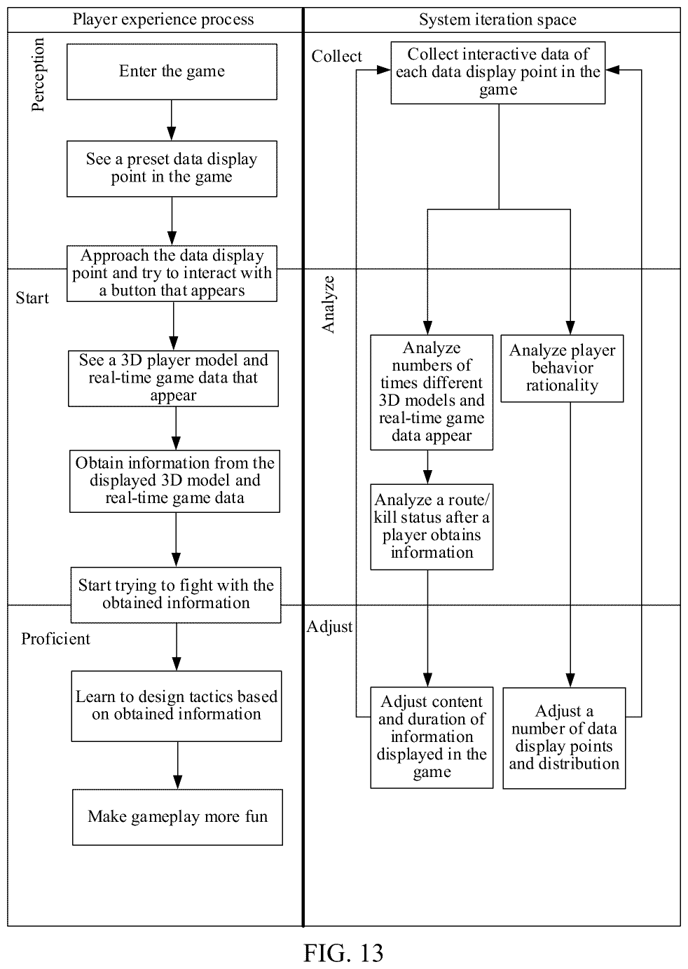

As a solution, the information display method is applied to a tactical competitive shooting game scene, for example, as shown in FIG. 13. Specific contents of a user experience process and a system iteration space are as follows:

### (1) User Experience Process:

Perception module: After a player enters a game, when the player sees a preset data display point in the game, the player approaches the data display point and tries to interact with a button that appears. The data display point may be used to display a virtual interactive prop, but this constitutes no limitation, and the button may be triggered to display after a relationship between the player and the data display point meets a condition, but this constitutes no limitation. The condition may be, but is not limited to, that a distance between the player and the data display point is less than a preset threshold, the player and the data display point are both located in a virtual safety scene environment, or the like.

Start module: After the player approaches the data point and tries to interact with the button that appears, the player sees a player 3D model and a real-time game data display in a form of a virtual projection, obtains information from the data, and starts to try to use the obtained information to combat.

Proficient module: After the player starts to try to use the obtained information to combat, the player starts to learn to design tactics based on the obtained information, thereby enriching the fun of the game.

When the information display method is applied to a tactical competitive shooting game scene, the player may quickly perceive its existence, understand its mechanism of action, and start to try to use information to combat, become proficient in using, and learn to design tactics based on the obtained information, thereby giving players more rich game experience and the fun of the game. Compared with mainstream solutions, the information display method can balance the needs of displaying the player 3D model and the real-time game data with less performance pressure, ensuring that players have sufficient space to obtain information.

### (2) System Iteration Space

Collection module: Interactive data from each data display point in the game is collected. Collection may be performed according to attributes such as player types, data display point types, and game session types, but this constitutes no limitation.

Analysis module: Based on the collected interactive data of the data display point, the number of occurrences of different 3D models and the number of occurrences of real-time game data in the virtual projection are analyzed, and statuses of routes/kills of the player in the game after the player obtains the information are analyzed and the rationality of player behavior is analyzed.

Adjustment module: Based on the analysis of the virtual projection information in the game and the performance data of the player after the player obtains the virtual projection information, the number and distribution of data display points in the game are adjusted, and the combat information content and duration in the game are adjusted.

The information display method is applied to a tactical competitive shooting game scenario. By collecting the numbers of occurrences of 3D models of different characters in the game and real-time game data displays and analyzing the performance data of the player after the player obtains the information, it is ensured that the system designer has sufficient space to adjust the content and duration of information displayed in the game and determine the future iteration direction of the system, and it is also easier to make character model settings that are consistent with the world view.

During the experience process, players need to learn to quickly deploy tactics based on related information of the obtained character models and real-time game data. This process is step-by-step. In the end, players may design tactics during the game based on props, character skills, and the like, to enrich game play methods and bring more diverse game experience. In addition, the system iteration space may also be adjusted based on distribution of the 3D model and the real-time game data display, to bring players more in-depth game experience.

As a solution, the information display method is applied to the virtual projection scene. Based on the information display method, a projection apparatus and trigger logic thereof are encapsulated in the same Actor, a Box collision body is added to the Actor and it is checked whether a collision channel is Character, and when the virtual character controlled by the player walks into the collision body, an interactive button is displayed to the player. If an interactive triggering operation of the player on the button is received, that is, the player requests to display the data of the model, the client DS requests background data and displays the 3D model and the real-time game data to the player.

To reduce memory and be compatible with low-end machines, the information display method is used to optimize the memory from many aspects. Details are as follows:

### (1) Unique on the Same Screen:

Only the main end interacts with a data segment (DS) register, and a simulation segment does not see the projection, ensuring that the projection does not affect other players. Combined with the proper placement location of the projection apparatus, it is ensured that there is only one 3D model and one real-time game data display on the same screen.

### (2) Narrow the Scope of Influence:

A clipping distance of levels of detail (LOD) of a collider is reduced to ensure that the collider does not affect players who are farther away. Only players who are close to the collider load the collider (e.g., data associated with the collider) to reduce memory as much as possible. An LOD technology refers to that rendering allocation of object rendering is determined based on a location and importance of a node of an object model in a display environment, reducing the number of faces and details of non-important objects, thereby obtaining efficient rendering operation.

### (3) Simplified Model:

In terms of models, to be compatible with low-end machines, low-poly (LowPoly) models with fewer faces are used to replace complex character models. Low-poly models can effectively reduce DrawCall and memory consumption. DrawCall may be understood as that a CPU calls an underlying graphics drawing interface to command the GPU to perform a rendering operation. The rendering process is implemented using a pipeline. The CPU and the GPU work in parallel and are connected through a command buffer. The CPU sends a rendering command to the GPU, and the GPU receives and executes the corresponding rendering command.

(4) Minimum guarantee mechanism: When the performance of some ultra-low-end machines is still under pressure, the method of displaying prompt information (Tips) is used instead of models to avoid affecting the normal player combat experience.

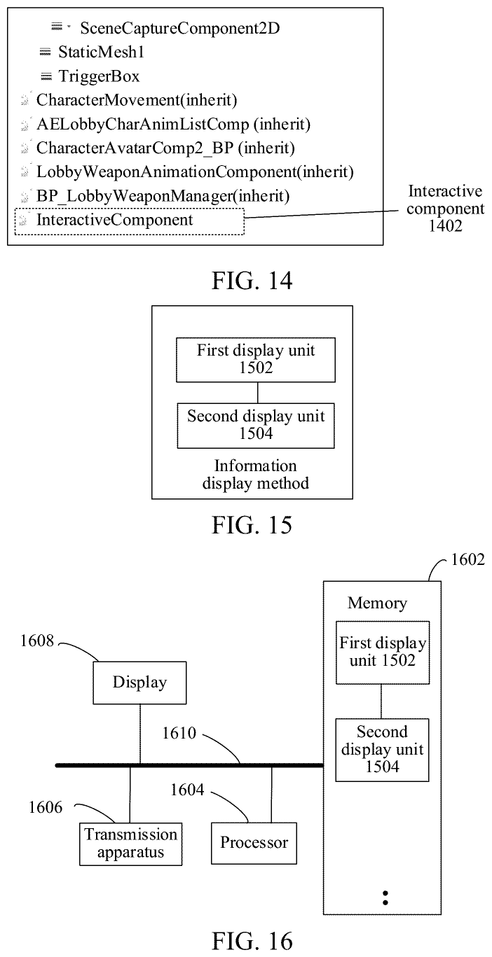

For another example, as shown in FIG. 14, in terms of program implementation, the display logic of the 3D model and real-time game data is reused, a subclass of the data is created, and an encapsulated interactive component 1402 is mounted on the subclass. Collision detection and button display methods are rewritten, the interaction range is set, and display of an interactive button is customized.

In a specific implementation of this disclosure, related data such as user information is involved, when the embodiments of this disclosure is applied to a specific product or technology, it is necessary to obtain the user permission or consent, and the collection, usage, and processing of related data need to comply with relevant laws, regulations and standards of relevant countries and regions.

To simplify the description, the foregoing method embodiments are described as a series of action combination. But the present disclosure is not limited to any described sequence of the action, as some operations may adopt other sequences or may be executed simultaneously according to the present disclosure. In addition, the embodiments described in the present specification are for illustration, and the actions and modules described with the embodiments are not necessarily mandatory.

According to another aspect of an embodiment of this disclosure, an information display apparatus for performing the foregoing information display method is further provided. As shown in FIG. 15, the apparatus includes:
a first display unit 1502, configured to: in a running process of a first virtual character participating in a current game task, display the first virtual character and a virtual interactive prop; and
a second display unit 1504, configured to: in response to a projection display operation performed on the virtual interactive prop, display a virtual projection corresponding to a second virtual character, the second virtual character being a virtual character that satisfies a projection condition and that are of virtual characters participating in the current game task, and the virtual projection including at least one of a character model projection of the second virtual character and a game data projection of the second virtual character.

For a specific embodiment, refer to the example in the foregoing information display apparatus, and details are not described herein again in this embodiment.

As a solution, the apparatus further includes:
a first display module, configured to: before the displaying, on a target client in response to a projection display operation performed on the virtual interactive prop, a virtual projection corresponding to a second virtual character, display a projection interactive control corresponding to the virtual interactive prop; and
an obtaining module, configured to: before the displaying, on a target client in response to a projection display operation performed on the virtual interactive prop, a virtual projection corresponding to a second virtual character, obtain a triggered projection operation performed on the projection interactive control, and determine the triggered projection operation as the projection display operation.

For a specific embodiment, refer to the example in the foregoing information display apparatus, and details are not described herein again in this embodiment.

As a solution, the first display module includes:
a first display submodule, configured to: when a distance between the first virtual character and the virtual interactive prop is less than or equal to a first threshold, display the projection interactive control.

For a specific embodiment, refer to the example in the foregoing information display apparatus, and details are not described herein again in this embodiment.

As a solution, the first display unit 1502 includes:
a second display module, configured to display the first virtual character located in a virtual safety scene and the virtual interactive prop located in the virtual safety scene, where the virtual safety scene is a virtual scene whose safety value is greater than or equal to a second threshold in the current game task.

For a specific embodiment, refer to the example in the foregoing information display apparatus, and details are not described herein again in this embodiment.

As a solution, the second display unit 1504 includes:
a third display module, configured to display the virtual projection on a target client, where the target client is a game client corresponding to the first virtual character, the virtual projection is prohibited from being displayed on any one of game clients other than the target client, and the game client is a client corresponding to the virtual character participating in the current game task.

For a specific embodiment, refer to the example in the foregoing information display apparatus, and details are not described herein again in this embodiment.

As a solution, the apparatus further includes:
a cancelling submodule, configured to: after the virtual projection is displayed on the target client, when a display duration of the virtual projection is greater than or equal to a preset threshold, cancel the display of the virtual projection, and delete display data corresponding to the virtual projection from the target client.

For a specific embodiment, refer to the example in the foregoing information display apparatus, and details are not described herein again in this embodiment.

As a solution, the apparatus further includes:
a first obtaining submodule, configured to: after the cancelling the display of the virtual projection, and deleting display data corresponding to the virtual projection from the target client, obtain the display data in response to the projection display operation; and
a second display submodule, configured to: after the cancelling the display of the virtual projection, and deleting display data corresponding to the virtual projection from the target client, display the virtual projection based on the display data, to display the virtual projection on the target client.

For a specific embodiment, refer to the example in the foregoing information display apparatus, and details are not described herein again in this embodiment.

As a solution, the apparatus further includes:
a placement module, configured to: before the displaying, in response to a projection display operation performed on the virtual interactive prop, a virtual projection corresponding to a second virtual character, in response to a prop pickup operation performed on the virtual interactive prop, place the virtual interactive prop in a virtual storage space associated with the first virtual character.

For a specific embodiment, refer to the example in the foregoing information display apparatus, and details are not described herein again in this embodiment.

As a solution, the apparatus further includes:
a third display submodule, configured to: after the placing, in response to a prop pickup operation performed on the virtual interactive prop, the virtual interactive prop in a virtual storage space associated with the first virtual character, in response to a first usage operation performed on the virtual interactive prop placed in the virtual storage space, display the virtual projection; or
a first adjustment submodule, configured to: after the placing, in response to a prop pickup operation performed on the virtual interactive prop, the virtual interactive prop in a virtual storage space associated with the first virtual character, in response to a holding triggering operation performed on the virtual interactive prop placed in the virtual storage space, adjust a state of the virtual interactive prop from a storage state to a holding state, where the state of the virtual interactive prop placed in the virtual storage space is the storage state; and display the virtual projection in response to a second usage operation performed on the virtual interactive prop in the holding state; or
a second adjustment submodule, configured to: after the placing, in response to a prop pickup operation performed on the virtual interactive prop, the virtual interactive prop in a virtual storage space associated with the first virtual character, in response to a triggering of a drop operation performed on the virtual interactive prop placed in the virtual storage space, adjust a state of the virtual interactive prop from the storage state to an unowned state, where the state of the virtual interactive prop not owned by the first virtual character is the unowned state; and display the virtual projection in response to a third usage operation performed on the virtual interactive prop in the unowned state.

For a specific embodiment, refer to the example in the foregoing information display apparatus, and details are not described herein again in this embodiment.

As a solution, the apparatus further includes:
a fourth display module, configured to: before the displaying, in response to a projection display operation performed on the virtual interactive prop, a virtual projection corresponding to a second virtual character, display a first projection configuration interface, where a plurality of projection character templates are displayed on the first projection configuration interface, and projection materials corresponding to the plurality of projection character templates are different;
a fifth display module, configured to: before the displaying, in response to a projection display operation performed on the virtual interactive prop, a virtual projection corresponding to a second virtual character, in response to a selection operation performed on a target projection template of the plurality of projection character templates, display a second projection configuration interface corresponding to the target projection template; and
a configuration module, configured to: before the displaying, in response to a projection display operation performed on the virtual interactive prop, a virtual projection corresponding to a second virtual character, in response to a configuration operation triggered on the second projection configuration interface, configure a display parameter of the target projection template, where the display parameter is configured for determining a display location of a projection element on a virtual projection matching the target projection template.

For a specific embodiment, refer to the example in the foregoing information display apparatus, and details are not described herein again in this embodiment.

As a solution, the second display unit 1504 further includes:
a second obtaining module, configured to: in response to the projection display operation, obtain N virtual characters participating in the current game task, where N is a natural number greater than or equal to 2;
a third obtaining module, configured to obtain target game data corresponding to each of the N virtual characters;
a determining module, configured to determine a target virtual character whose target game data satisfies the projection condition from the N virtual characters, and determine the target virtual character as the second virtual character; and
a sixth display module, configured to display the virtual projection.

For a specific embodiment, refer to the example in the foregoing information display apparatus, and details are not described herein again in this embodiment.

As a solution, the third obtaining module further includes:
a second obtaining submodule, configured to obtain first game data corresponding to each of the N virtual characters, where the first game data is real-time game data of each of the N virtual characters participating in the current game task;
a third obtaining submodule, configured to obtain second game data corresponding to each of the N virtual characters, where the second game data is game data of each of the N virtual characters participating in a target virtual game, and the current game task is a game task in the target virtual game; and
a fourth obtaining submodule, configured to obtain third game data corresponding to each of the N virtual characters, where the third game data is game data of each of the N virtual characters participating in a plurality of game tasks in the target virtual game.

As a solution, the apparatus further includes:
a determining unit, configured to: before the displaying, in response to a projection display operation performed on the virtual interactive prop, a virtual projection corresponding to a second virtual character, when the first virtual character is located in a collision area associated with the virtual interactive prop, determine that the first virtual character collides with the virtual interactive prop, and obtain the projection display operation.

For a specific embodiment, refer to the example in the foregoing information display apparatus, and details are not described herein again in this embodiment.

As a solution, the second display unit includes:
a ninth display module, configured to display a virtual projection corresponding to a third virtual character, where the third virtual character is a virtual character that satisfies the projection condition and that is of virtual characters in the same camp as the first virtual character participating in the current game task.

For a specific embodiment, refer to the example in the foregoing information display apparatus, and details are not described herein again in this embodiment.

For a specific embodiment, refer to the example in the foregoing information display apparatus, and details are not described herein again in this embodiment.

As a solution, the second display unit 1504 further includes:
a seventh display module, configured to display a character model projection corresponding to the second virtual character; and
an eighth display module, configured to display a game data projection corresponding to the second virtual character.

For a specific embodiment, refer to the example in the foregoing information display apparatus, and details are not described herein again in this embodiment.

According to another aspect of an embodiment of the present disclosure, an electronic device for implementing the foregoing information display method is further provided. As shown in FIG. 16, the electronic device includes a memory 1602 and a processor 1604. The memory 1602 stores a computer program, and the processor 1604 is configured to perform the operations of any one of the foregoing method embodiments through the computer program.

In some examples, in this embodiment, the electronic device may be located in at least one of a plurality of network devices in a computer network.

In some examples, in this embodiment, the processor may be configured to perform the following operations through the computer program:
S1: In a running process of a first virtual character participating in a current game task, display the first virtual character and a virtual interactive prop.
S2: In response to a projection display operation performed on the virtual interactive prop, display a virtual projection corresponding to a second virtual character, the second virtual character being a virtual character that satisfies a projection condition and that are of virtual characters participating in the current game task, and the virtual projection including at least one of a character model projection of the second virtual character and a game data projection of the second virtual character.

It is noted that the structure shown in FIG. 16 is only schematic. The electronic device may be a terminal device such as a smartphone (such as an Android mobile phone or an iOS mobile phone), a tablet computer, a palmtop computer, a mobile Internet device (MID), or a PAD. FIG. 16 does not limit the structure of the electronic device. For example, the electronic device may further include more or less components (for example, a network interface) than those shown in FIG. 16, or has a configuration different from that shown in FIG. 16.

The memory 1602 may be configured to store a software program and a module, for example, a program instruction/module corresponding to the information display method and apparatus in an embodiment of this disclosure, and the processor 1604 performs various functional applications and data processing by running a software program and a module stored in the memory 1602, that is, implementing the foregoing information display method. The memory 1602 may include a high-speed random memory, and may also include a non-volatile memory, for example, one or more magnetic storage apparatuses, a flash memory, or another nonvolatile solid-state memory. In some embodiments, the memory 1602 may further include memories remotely disposed relative to the processor 1604, and the remote memories may be connected to a terminal through a network. Examples of the network include, but are not limited to, the Internet, an intranet, a local area network, a mobile communication network, and a combination thereof. The memory 1602 may be specifically configured to, but is not limited to, store information such as virtual projections corresponding to the first virtual character, the virtual interactive prop, and the second virtual character. As an example, as shown in FIG. 16, the memory 1602 may include, but is not limited to, the first display unit 1502 and the second display unit 1504 in the information display apparatus. In addition, the memory may also include, but is not limited to, other modular units in the information display apparatus, and details are not described again in this example.

In some examples, the transmission apparatus 1606 is configured to receive or send data by using a network. Specific examples of the foregoing network include a wired network and a wireless network. In an example, the transmission apparatus 1606 includes a network interface controller (NIC), which may be connected to another network device and a router by using a network cable, so as to communicate with the Internet or a local area network. In an example, the transmission apparatus 1606 is a radio frequency (RF) module, which communicates with the Internet in a wireless manner.

Besides, the electronic device further includes: a display 1608, configured to display information such as virtual projections corresponding to the first virtual character, the virtual interactive prop, and the second virtual character; and a connection bus 1610, configured to connect various module components in the electronic device.

In another embodiment, the terminal device or the server may be a node in a distributed system, where the distributed system may be a blockchain system, and the blockchain system may be a distributed system formed by connecting a plurality of nodes through network communication. Nodes may form a peer-to-peer (P2P) network, and any form of computing device, such as a server, a terminal, and other electronic devices, may become a node in the blockchain system by joining the peer-to-peer network.

According to an aspect of the present disclosure, a computer program product is provided, including a computer program/instruction including program code for executing the method shown in the flowchart. In such an embodiment, the computer program may be downloaded and installed from a network through a communication part, and/or installed from a removable medium. When the computer program is executed by the CPU, the various functions defined in the system of this embodiment of this disclosure are executed.

The sequence numbers of the foregoing embodiments of this disclosure are merely for description purpose but do not imply the preference among the embodiments.

The computer system of the electronic device is merely an example, and does not constitute any limitation on functions and use ranges of the embodiments of this disclosure.

The computer system includes a central processing unit (CPU), which may perform various suitable actions and processing based on a program stored in a read-only memory (ROM) or a program loaded from a storage part into a random access memory (RAM). The random access memory further stores various programs and data required for system operations. The central processing unit, the read-only memory, and the random access memory are connected to each other through a bus. An input/output (I/O) interface is also connected to the bus.

The following components are connected to the input/output interface: input parts such as a keyboard and a mouse, and output parts such as a cathode ray tube (CRT), a liquid crystal display (LCD), and a speaker, and storage parts such as hard drives; and communication parts such as network interface cards, for example, LAN cards and modems. The communication part performs communication processing by using a network such as the Internet. A driver is also connected to the I/O interface as required. A removable medium, such as a magnetic disk, an optical disc, a magneto-optical disk, or a semiconductor memory, is installed on the driver as required, so that a computer program read from the removable medium is installed into the storage part as required.

Particularly, according to an embodiment of this disclosure, the processes described in the method flowcharts may be implemented as computer software programs. For example, this embodiment of this disclosure includes a computer program product, the computer program product includes a computer program carried on a computer-readable medium, and the computer program includes program code for performing the methods shown in the flowcharts. In such an embodiment, the computer program may be downloaded and installed from a network through a communication part, and/or installed from a removable medium. When the computer program is executed by the central processing unit, the various functions defined in the system of this disclosure are executed.

According to an aspect of this disclosure, a computer-readable storage medium is provided. A processor of a computer device reads the computer instructions from the computer-readable storage medium, and the processor executes the computer instructions, so that the computer device performs the method according to the foregoing implementations.

In some examples, in this embodiment, the computer-readable storage medium may be configured to store a computer program for performing the following operations:
S1: In a running process of a first virtual character participating in a current game task, display the first virtual character and a virtual interactive prop.
S2: In response to a projection display operation performed on the virtual interactive prop, display a virtual projection corresponding to a second virtual character, the second virtual character being a virtual character that satisfies a projection condition and that are of virtual characters participating in the current game task, and the virtual projection including at least one of a character model projection of the second virtual character and a game data projection of the second virtual character.

It is noted that all or some operations in the methods in the foregoing embodiments may be performed by a program instructing related hardware of a terminal device. The program may be stored in a non-transitory computer-readable storage medium. The storage medium may include: a flash drive, a read-only memory (ROM), a random access memory (RAM), a magnetic disk, an optical disc, and the like.

The sequence numbers of the embodiments of this disclosure are merely for description purpose but do not imply the preference among the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device or the like) to perform all or some of operations of the methods in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, the disclosed client may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of this disclosure may be integrated into one processing unit (also referred to as processing circuitry in some examples), or each of the units may be physically separated, or two or more units may be integrated into one unit. The integrated unit may be implemented in the form of hardware, or may be implemented in a form of a software functional unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely exemplary implementations of this disclosure. Modifications can be made without departing from the principle of this disclosure.

What is claimed is:

1. A method for information display, comprising:
displaying, during a process of a current game task that includes a first virtual character, the first virtual character and a virtual interactive prop in the current game task; and
when a projection display operation is performed on the virtual interactive prop, displaying a virtual projection associated with a second virtual character that is included in the current game task and satisfies a projection condition, the virtual projection comprising at least one of a character model projection of the second virtual character and a game data projection of the second virtual character.

2. The method according to claim 1, further comprising:
displaying a projection interactive control associated withs the virtual interactive prop;
detecting a triggered projection operation performed on the projection interactive control; and
determining the projection display operation based on the triggered projection operation.

3. The method according to claim 2, wherein the displaying the projection interactive control comprises:
when a distance between the first virtual character and the virtual interactive prop is less than or equal to a first threshold, displaying the projection interactive control.

4. The method according to claim 1, wherein the displaying the first virtual character and the virtual interactive prop comprises:
displaying the first virtual character and the virtual interactive prop located in a virtual safety scene with a safety value greater than or equal to a second threshold in the current game task.

5. The method according to claim 1, wherein the displaying the virtual projection comprises:
displaying the virtual projection on a first client associated with the first virtual character, the virtual projection is prohibited from being displayed on a second client associated with another virtual character in the current game task that is other than the first virtual character.

6. The method according to claim 5, further comprising:
when a display duration of the virtual projection is greater than or equal to a preset threshold:
stop the virtual projection from display; and
deleting, from the first client, display data of the virtual projection.

7. The method according to claim 6, wherein the projection display operation is a first projection display operation, the method further comprises:
obtaining the display data when a second projection display operation is performed on the virtual interactive prop; and
displaying the virtual projection on the first client based on the display data.

8. The method according to claim 1, further comprising:
when a prop pickup operation is performed on the virtual interactive prop, placing the virtual interactive prop in a virtual storage space associated with the first virtual character.

9. The method according to claim 8, further comprising:
when a usage operation is performed on the virtual interactive prop that is placed in the virtual storage space, displaying the virtual projection.

10. The method according to claim 8, further comprising:
when a holding triggering operation is performed on the virtual interactive prop that is placed in the virtual storage space, adjusting the virtual interactive prop from a storage state to a holding state, the storage state indicating the virtual interactive prop being placed in the virtual storage space, the holding state indicating the virtual interactive prop being held by the first virtual character; and
displaying the virtual projection when a usage operation is performed on the virtual interactive prop in the holding state.

11. The method according to claim 8, further comprising:
when a triggering of a drop operation is performed on the virtual interactive prop that is placed in the virtual storage space, adjusting the virtual interactive prop from a storage state to an unowned state, the storage state indicating the virtual interactive prop being placed in the virtual storage space, the unowned state indicating the virtual interactive prop not being owned by the first virtual character; and
displaying the virtual projection in response to a usage operation performed on the virtual interactive prop in the unowned state.

12. The method according to claim 1, further comprising:
displaying a first projection configuration interface that includes a plurality of projection character templates with respective projection materials;
when a selection operation is performed on a target projection template in the plurality of projection character templates, displaying a second projection configuration interface associated with the target projection template; and
when a configuration operation is triggered on the second projection configuration interface, configuring a display parameter of the target projection template, the display parameter indicating a display location of a projection element on a subsequent virtual projection using the target projection template.

13. The method according to claim 1, wherein the displaying the virtual projection comprises:
obtaining N virtual characters that are included in the current game task, N being a natural number greater than or equal to 2;
obtaining target game data associated with each of the N virtual characters;
determining, from the N virtual characters, the second virtual character whose target game data satisfies the projection condition; and
displaying the virtual projection associated with the second virtual character.

14. The method according to claim 13, wherein the obtaining the target game data comprises:
obtaining real-time game data associated with each of the N virtual characters in the current game task.

15. The method according to claim 13, wherein the obtaining the target game data comprises:
obtaining the target game data associated with each of the N virtual characters in a single game task of a target virtual game.

16. The method according to claim 13, wherein the obtaining the target game data comprises:
obtaining the target game data associated with each of the N virtual characters in a plurality of game tasks in a target virtual game.

17. The method according to claim 1, further comprising:
when the first virtual character is located in a collision area associated with the virtual interactive prop;
determining that the first virtual character collides with the virtual interactive prop; and
obtaining the projection display operation.

18. The method according to claim 1, wherein the second virtual character is in a same camp as the first virtual character in the current game task, and satisfies the projection condition.

19. An apparatus, comprising processing circuitry configured to:
display, during a process of a current game task that includes a first virtual character, the first virtual character and a virtual interactive prop in the current game task; and
when a projection display operation is performed on the virtual interactive prop, display a virtual projection associated with a second virtual character that is included in the current game task and satisfies a projection condition, the virtual projection comprising at least one of a character model projection of the second virtual character and a game data projection of the second virtual character.

20. A non-transitory computer-readable storage medium storing instructions which when executed by at least one processor cause the at least one processor to perform:
displaying, during a process of a current game task includes a first virtual character, the first virtual character and a virtual interactive prop in the current game task; and
when a projection display operation is performed on the virtual interactive prop, displaying a virtual projection associated with a second virtual character is included in the current game task and satisfies a projection condition, the virtual projection comprising at least one of a character model projection of the second virtual character and a game data projection of the second virtual character.
